(19) United States
(12) Patent Application Publication
(10) Pub. No.: US 2019/0243443 A1
(43) Pub. Date: Aug. 8, 2019

(54) PROGRAM, INFORMATION PROCESSING APPARATUS AND METHOD THEREOF

(71) Applicant: COLOPL, Inc., Tokyo (JP)

(72) Inventor: Toshiki ANDO, Tokyo (JP)

(21) Appl. No.: 16/258,670

(22) Filed: Jan. 28, 2019

(30) Foreign Application Priority Data
Jan. 31, 2018 (JP) 2018-015784

(51) Int. Cl. G06F 3/01; G06F 3/0481; G06T 19/20

(52) U.S. Cl. CPC G06F 3/011; G06T 19/20; G06F 3/04815

(57) ABSTRACT

A method includes receiving content. The method further includes identifying a first peripheral device connected to a computer and a first function associated with the first peripheral device. The method further includes identifying a second peripheral device connected to the computer and a second function associated with the second peripheral device. The method further includes instructing a display to display a first option corresponding to the first function and a second option corresponding to the second function. The method further includes receiving an input from a user, wherein the input corresponds to selection of the first option or selection of the second option. The method further includes transmitting information based on the received input. The method further includes receiving instructions for activating the first function or the second function based on the transmitted information. The method includes activating the first function or the second function based on the received instructions.

### RELATED APPLICATIONS

The present application claims priority to Japanese Application No. 2018-015784, filed on Jan. 31, 2018, the disclosure of which is hereby incorporated by reference herein in its entirety.

### TECHNICAL FIELD

The present description relates to an information processing apparatus and a method of using the same.

### BACKGROUND

Patent Document 1 describes a game system operation method. Specifically, when a second storage medium is provided to a game apparatus, the game apparatus while loading a certain key is activated by both a standard game program and/or data and an extended game program and/or data, whereas the game apparatus while not loading a certain key is activated only by a standard game program and/or data.

### CITATION LIST

### Patent Document

[Patent Document 1] JP 8-161164 A

### SUMMARY

A method according to at least one aspect of the present description is a method to be executed by a computer including a processor and in communication with a display. The method includes transmitting first information for specifying content executed by the computer to a server. The method further includes identifying a first peripheral device connected to the computer, the first peripheral device being configured to operate the content. The method further includes identifying a first function, the first function being associated with the first peripheral device, the first function differing from a second function associated with a second peripheral device that differs from the first peripheral device. The method further includes instructing the display to display a first option corresponding to the first function and a second option corresponding to the second function. The method further includes selecting the first option based on an input made by a user. The method further includes transmitting second information for specifying the first function to the server. The method further includes receiving third information for activating the first function on the content from the server. The method further includes activating the first function on the content by use of the third information.

### BRIEF DESCRIPTION OF DRAWINGS

FIG. 1 A diagram of a system including a head-mounted device (HMD) according to at least one embodiment of this disclosure.

FIG. 2 A block diagram of a hardware configuration of a computer according to at least one embodiment of this disclosure.

FIG. 3 A diagram of a uvw visual-field coordinate system to be set for an HMD according to at least one embodiment of this disclosure.

FIG. 4 A diagram of a mode of expressing a virtual space according to at least one embodiment of this disclosure.

FIG. 5 A diagram of a plan view of a head of a user wearing the HMD according to at least one embodiment of this disclosure.

FIG. 6 A diagram of a YZ cross section obtained by viewing a field-of-view region from an X direction in the virtual space according to at least one embodiment of this disclosure.

FIG. 7 A diagram of an XZ cross section obtained by viewing the field-of-view region from a Y direction in the virtual space according to at least one embodiment of this disclosure.

FIG. 8A A diagram of a schematic configuration of a controller according to at least one embodiment of this disclosure.

FIG. 8B A diagram of a coordinate system to be set for a hand of a user holding the controller according to at least one embodiment of this disclosure.

FIG. 9 A block diagram of a hardware configuration of a server according to at least one embodiment of this disclosure.

FIG. 10 A block diagram of a computer according to at least one embodiment of this disclosure.

FIG. 11 A sequence chart of processing to be executed by a system including an HMD set according to at least one embodiment of this disclosure.

FIG. 12A A schematic diagram of HMD systems of several users sharing the virtual space interact using a network according to at least one embodiment of this disclosure.

FIG. 12B A diagram of a field of view image of a HMD according to at least one embodiment of this disclosure.

FIG. 13 A sequence diagram of processing to be executed by a system including an HMD interacting in a network according to at least one embodiment of this disclosure.

FIG. 14 A block diagram of modules in a server according to at least one embodiment of this disclosure.

FIG. 15 A block diagram of a configuration of modules in a computer according to at least one embodiment of this disclosure.

FIG. 16 A flowchart of processing to be executed by a system including an HMD set and a server according to at least one embodiment of this disclosure.

FIG. 17 A diagram of a display for enabling a user to select a function serving as an activation target according to at least one embodiment of this disclosure.

FIG. 18A A diagram of a field-of-view image according to at least one embodiment of this disclosure.

FIG. 18B A diagram of a field-of-view image according to at least one embodiment of this disclosure.

FIG. 19A A diagram of a field-of-view image according to at least one embodiment of this disclosure.

FIG. 19B A diagram of a field-of-view image according to at least one embodiment of this disclosure.

### DETAILED DESCRIPTION

Now, with reference to the drawings, embodiments of this technical idea are described in detail. In the following description, like components are denoted by like reference symbols. The same applies to the names and functions of those components. Therefore, detailed description of those components is not repeated. In one or more embodiments described in this disclosure, components of respective embodiments can be combined with each other, and the combination also serves as a part of the embodiments described in this disclosure.

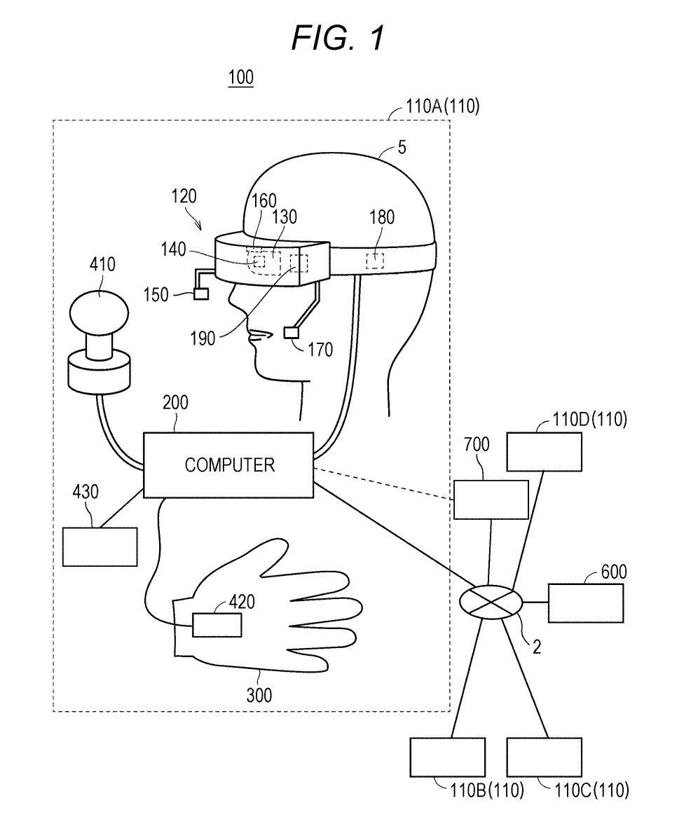

With reference to FIG. 1, a configuration of a head-mounted device (HMD) system 100 is described according to at least one embodiment. FIG. 1 is a diagram of a system 100 including a head-mounted display (HMD) according to at least one embodiment of this disclosure. The system 100 is usable for household use or for professional use.

The system 100 includes a server 600, HMD sets 110A, 110B, 110C, and 110D, an external device 700, and a network 2. Each of the HMD sets 110A, 110B, 110C, and 110D is capable of independently communicating to/from the server 600 or the external device 700 via the network 2. In some instances, the HMD sets 110A, 110B, 110C, and 110D are also individually referred to as “HMD set 110”. The number of HMD sets 110 constructing the HMD system 100 is not limited to four, but may be three or less, or five or more. The HMD set 110 includes an HMD 120, a computer 200, an HMD sensor 410, a display 430, and a controller 300. The HMD 120 includes a monitor 130, an eye gaze sensor 140, a first camera 150, a second camera 160, a microphone 170, and a speaker 180. In at least one embodiment, the controller 300 includes a motion sensor 420.

In at least one aspect, the computer 200 is connected to the network 2, for example, the Internet, and is able to communicate to/from the server 600 or other computers connected to the network 2 in a wired or wireless manner. Examples of the other computers include a computer of another HMD set 110 or the external device 700. In at least one aspect, the HMD 120 includes a sensor 190 instead of the HMD sensor 410. In at least one aspect, the HMD 120 includes both sensor 190 and the HMD sensor 410.

The HMD 120 is wearable on a head of a user 5 to display a virtual space to the user 5 during operation. More specifically, in at least one embodiment, the HMD 120 displays a right-eye image and a left-eye image on the monitor 130. Each eye of the user 5 is able to visually recognize a corresponding image from the right-eye image and the left-eye image so that the user 5 may recognize a three-dimensional image based on the parallax of both of the user's the eyes. In at least one embodiment, the HMD 120 includes any one of a so-called head-mounted display including a monitor or a head-mounted device capable of mounting a smartphone or other terminals including a monitor.

The monitor 130 is implemented as, for example, a non-transmissive display device. In at least one aspect, the monitor 130 is arranged on a main body of the HMD 120 so as to be positioned in front of both the eyes of the user 5. Therefore, the user 5 is able to visually recognize the three-dimensional image displayed by the monitor 130, and the user 5 is immersed in the virtual space. In at least one aspect, the virtual space includes, for example, a background, objects that are operable by the user 5, or menu images that are selectable by the user 5. In at least one aspect, the monitor 130 is implemented as a liquid crystal monitor or an organic electroluminescence (EL) monitor included in a so-called smartphone or other information display terminals.

In at least one aspect, the monitor 130 is implemented as a transmissive display device. In this case, the user 5 is able to see through the HMD 120 covering the eyes of the user 5, for example, smartglasses. In at least one embodiment, the transmissive monitor 130 is configured as a temporarily non-transmissive display device through adjustment of a transmittance thereof. In at least one embodiment, the monitor 130 is configured to display a real space and a part of an image constructing the virtual space simultaneously. For example, in at least one embodiment, the monitor 130 displays an image of the real space captured by a camera mounted on the HMD 120. In at least one embodiment, the monitor 130 enables recognition of the real space by setting the transmittance of a part the monitor 130 sufficiently high to permit the user 5 to see through the HMD 120.

In at least one aspect, the monitor 130 includes a sub-monitor for displaying a right-eye image and a sub-monitor for displaying a left-eye image. In at least one aspect, the monitor 130 is configured to integrally display the right-eye image and the left-eye image. In at least one embodiment, the monitor 130 includes a high-speed shutter. The high-speed shutter operates so as to alternately display the right-eye image to the right of the user 5 and the left-eye image to the left eye of the user 5, so that only one of the user's 5 eyes is able to recognize the image at any single point in time.

In at least one aspect, the HMD 120 includes a plurality of light sources (not shown). Each light source is implemented by, in at least one embodiment, a light emitting diode (LED) configured to emit an infrared ray. The HMD sensor 410 has a position tracking function for detecting the motion of the HMD 120. More specifically, the HMD sensor 410 reads a plurality of infrared rays emitted by the HMD 120 to detect the position and the inclination of the HMD 120 in the real space.

In at least one aspect, the HMD sensor 410 is implemented using a camera. In at least one aspect, the HMD sensor 410 uses image information of the HMD 120 output from the camera to execute image analysis processing, to thereby enable detection of the position and the inclination of the HMD 120.

In at least one aspect, the HMD 120 includes the sensor 190 instead of, or in addition to, the HMD sensor 410 as a position detector. In at least one aspect, the HMD 120 uses the sensor 190 to detect the position and the inclination of the HMD 120. For example, in at least one embodiment, when the sensor 190 includes an angular velocity sensor, a geomagnetic sensor, or an acceleration sensor. In at least one embodiment, the sensor 190 includes an angular velocity sensor, and the angular velocity sensor detects over time the angular velocity about each of three axes of the HMD 120 in the real space. The HMD 120 calculates a temporal change of the angle about each of the three axes of the HMD 120 based on each angular velocity, and further determines an inclination of the HMD 120 based on the temporal change of the angles.

The eye gaze sensor 140 detects a direction in which the a line of sight of the right eye and a line of sight of the left eye of the user 5 are directed. That is, the eye gaze sensor 140 detects the line of sight of the user 5. The direction of the line of sight is detected by, for example, a known eye tracking function. The eye gaze sensor 140 is implemented by a sensor having the eye tracking function. In at least one aspect, the eye gaze sensor 140 includes a right-eye sensor and a left-eye sensor. In at least one embodiment, the eye gaze sensor 140 is, for example, a sensor configured to irradiate the right eye and the left eye of the user 5 with an infrared ray, and to receive reflection light from the cornea and the iris with respect to the irradiation light, to thereby detect a rotational angle of each of the user's 5 eyeballs. In at least one embodiment, the eye gaze sensor 140 detects the line of sight of the user 5 based on each detected rotational angle.

The first camera 150 captures an image of a lower part of a face of the user 5. More specifically, the first camera 150 captures an image of, for example, the nose or mouth of the user 5. The second camera 160 captures an image of, for example, the eyes and eyebrows of the user 5. A side of a casing of the HMD 120 on the user 5 side is defined as an interior side of the HMD 120, and a side of the casing of the HMD 120 on a side opposite to the user 5 side is defined as an exterior side of the HMD 120. In at least one aspect, the first camera 150 is arranged on an exterior side of the HMD 120, and the second camera 160 is arranged on an interior side of the HMD 120. Images generated by the first camera 150 and the second camera 160 are input to the computer 200. In at least one aspect, the first camera 150 and the second camera 160 are implemented as a single camera, and an image of the face of the user 5 is captured with this single camera.

The microphone 170 converts an utterance of the user 5 into a voice signal (electric signal) for output to the computer 200. The speaker 180 converts an audio signal into a sound for output to the user 5. In at least one embodiment, the speaker 180 converts other signals into audio information provided to the user 5. In at least one aspect, the HMD 120 includes earphones in place of, or in addition to, the speaker 180.

The controller 300 is connected to the computer 200 through wired or wireless communication. The controller 300 receives input of a command from the user 5 to the computer 200. In at least one aspect, the controller 300 is held by the user 5. In at least one aspect, the controller 300 is mountable to the body of the user 5 or a part of the clothes of the user 5. In at least one aspect, the controller 300 is configured to output at least one of a vibration, a sound, or light based on the signal transmitted from the computer 200. In at least one aspect, the controller 300 receives from the user 5 an operation for controlling the position and the motion of an object arranged in the virtual space.

In at least one aspect, the controller 300 includes a plurality of light sources. Each light source is implemented using, for example, an LED configured to emit an infrared ray. The HMD sensor 410 has a position tracking function. In this case, the HMD sensor 410 reads a plurality of infrared rays emitted by the controller 300 to detect the position and the inclination of the controller 300 in the real space. In at least one aspect, the HMD sensor 410 is implemented using a camera. In this case, the HMD sensor 410 uses image information of the controller 300 output from the camera to execute image analysis processing, to thereby enable detection of the position and the inclination of the controller 300.

In at least one aspect, the motion sensor 420 is mountable on the hand of the user 5 to detect the motion of the hand of the user 5. For example, the motion sensor 420 detects a rotational speed, a rotation angle, and the number of rotations of the hand. The detected signal is transmitted to the computer 200. The motion sensor 420 is provided to, for example, the controller 300. In at least one aspect, the motion sensor 420 is provided to, for example, the controller 300 capable of being held by the user 5. In at least one aspect, to help prevent accidental release of the controller 300 in the real space, by the user 5, the controller 300 is mountable on an object like a glove-type object that is not easily released because the controller is worn on a hand of the user 5. In at least one aspect, a sensor that is not mountable on the user 5 detects the motion of the hand of the user 5. For example, a signal of a camera that captures an image of the user 5 may be input to the computer 200 as a signal representing the motion of the user 5. As at least one example, the motion sensor 420 and the computer 200 are connected to each other through wired or wireless communication. In the case of wireless communication, the communication mode is not particularly limited, and for example, Bluetooth (trademark) or other known communication methods are usable.

The display 430 displays an image similar to an image displayed on the monitor 130. With this, a user other than the user 5 wearing the HMD 120 can also view an image similar to that of the user 5. In at least one embodiment, an image to be displayed on the display 430 is not a three-dimensional image, but may be a right-eye image or a left-eye image. In at least one embodiment, the other user is able to wear glasses for viewing the image of display 430 as a three dimensional image. For example, a liquid crystal display or an organic EL monitor may be used as the display 430.

In at least one embodiment, the server 600 transmits a program to the computer 200. In at least one aspect, the server 600 communicates to/from another computer 200 for providing virtual reality to the HMD 120 used by another user. For example, when a plurality of users play a participatory game, for example, in an amusement facility, each computer 200 communicates to/from another computer 200 via the server 600 with a signal that is based on the motion of each user, to thereby enable the plurality of users to enjoy a common game in the same virtual space. Each computer 200 may communicate to/from another computer 200 with the signal that is based on the motion of each user without intervention of the server 600.

The external device 700 is any suitable device as long as the external device 700 is capable of communicating to/from the computer 200. The external device 700 is, for example, a device capable of communicating to/from the computer 200 via the network 2, or is a device capable of directly communicating to/from the computer 200 by near field communication or wired communication. Peripheral devices such as a smart device, a personal computer (PC), or the computer 200 are usable as the external device 700, in at least one embodiment, but the external device 700 is not limited thereto.

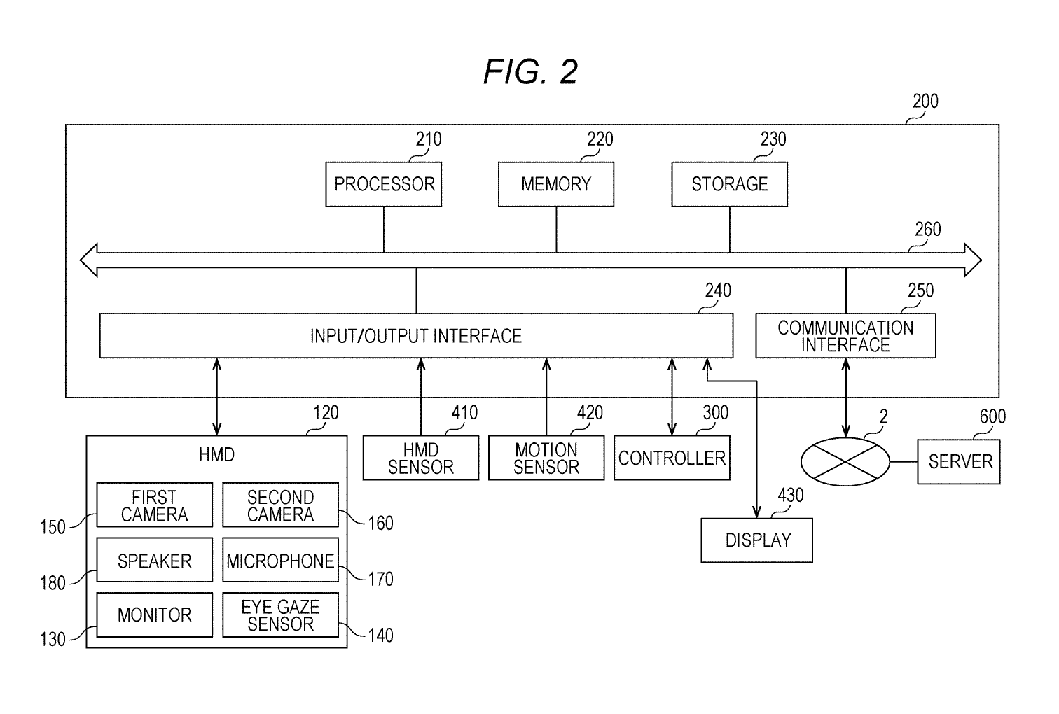

With reference to FIG. 2, the computer 200 in at least one embodiment is described. FIG. 2 is a block diagram of a hardware configuration of the computer 200 according to at least one embodiment. The computer 200 includes, a processor 210, a memory 220, a storage 230, an input/output interface 240, and a communication interface 250. Each component is connected to a bus 260. In at least one embodiment, at least one of the processor 210, the memory 220, the storage 230, the input/output interface 240 or the communication interface 250 is part of a separate structure and communicates with other components of computer 200 through a communication path other than the bus 260.

The processor 210 executes a series of commands included in a program stored in the memory 220 or the storage 230 based on a signal transmitted to the computer 200 or in response to a predetermined condition. In at least one aspect, the processor 210 is implemented as a central processing unit (CPU), a graphics processing unit (GPU), a micro-processor unit (MPU), a field-programmable gate array (FPGA), or other devices.

The memory 220 stores programs and data. In at least one embodiment, the memory 220 stores programs and data during operation of computer 200. The programs are loaded from, for example, the storage 230. The data includes data input to the computer 200 and data generated by the processor 210. In at least one aspect, the memory 220 is implemented as a random access memory (RAM) or another volatile memory.

The storage 230 stores programs and data. In at least one embodiment, the storage 230 stores programs and data even during non-operation of the computer 200. In at least one embodiment, the storage 230 stores programs and data for a period of time longer than the memory 220. The storage 230 is implemented as, for example, a read-only memory (ROM), a hard disk device, a flash memory, or another non-volatile storage device. The programs stored in the storage 230 include programs for providing a virtual space in the system 100, simulation programs, game programs, user authentication programs, or programs for implementing communication to/from other computers 200. The data stored in the storage 230 includes data and objects for defining the virtual space.

In at least one aspect, the storage 230 is implemented as a removable storage device like a memory card. In at least one aspect, a configuration that uses programs and data stored in an external storage device is used instead of the storage 230 built into the computer 200. With such a configuration, for example, in a situation in which a plurality of HMD systems 100 are used, for example in an amusement facility, the programs and the data are collectively updated.

The input/output interface 240 allows communication of signals among the HMD 120, the HMD sensor 410, the motion sensor 420, and the display 430. The monitor 130, the eye gaze sensor 140, the first camera 150, the second camera 160, the microphone 170, and the speaker 180 included in the HMD 120 may communicate to/from the computer 200 via the input/output interface 240 of the HMD 120. In at least one aspect, the input/output interface 240 is implemented with use of a universal serial bus (USB), a digital visual interface (DVI), a high-definition multimedia interface (HDMI) (trademark), or other terminals. The input/output interface 240 is not limited to the specific examples described above.

In at least one aspect, the input/output interface 240 further communicates to/from the controller 300. For example, the input/output interface 240 receives input of a signal output from the controller 300 and the motion sensor 420. In at least one aspect, the input/output interface 240 transmits a command output from the processor 210 to the controller 300. The command instructs the controller 300 to, for example, vibrate, output a sound, or emit light. When the controller 300 receives the command, the controller 300 executes any one of vibration, sound output, and light emission in accordance with the received command.

The communication interface 250 is connected to the network 2 to communicate to/from other computers (e.g., server 600) connected to the network 2. In at least one aspect, the communication interface 250 is implemented as, for example, a local area network (LAN), other wired communication interfaces, wireless fidelity (Wi-Fi), Bluetooth®, near field communication (NFC), or other wireless communication interfaces. The communication interface 250 is not limited to the specific examples described above.

In at least one aspect, the processor 210 accesses the storage 230 and loads one or more programs stored in the storage 230 to the memory 220 to execute a series of commands included in the program. In at least one embodiment, the one or more programs includes an operating system of the computer 200, an application program for providing a virtual space, and/or game software that is executable in the virtual space. The processor 210 transmits a signal for providing a virtual space to the HMD 120 via the input/output interface 240. The HMD 120 displays a video on the monitor 130 based on the signal.

In FIG. 2, the computer 200 is outside of the HMD 120, but in at least one aspect, the computer 200 is integral with the HMD 120. As an example, a portable information communication terminal (e.g., smartphone) including the monitor 130 functions as the computer 200 in at least one embodiment.

In at least one embodiment, the computer 200 is used in common with a plurality of HMDs 120. With such a configuration, for example, the computer 200 is able to provide the same virtual space to a plurality of users, and hence each user can enjoy the same application with other users in the same virtual space.

According to at least one embodiment of this disclosure, in the system 100, a real coordinate system is set in advance. The real coordinate system is a coordinate system in the real space. The real coordinate system has three reference directions (axes) that are respectively parallel to a vertical direction, a horizontal direction orthogonal to the vertical direction, and a front-rear direction orthogonal to both of the vertical direction and the horizontal direction in the real space. The horizontal direction, the vertical direction (up-down direction), and the front-rear direction in the real coordinate system are defined as an x axis, a y axis, and a z axis, respectively. More specifically, the x axis of the real coordinate system is parallel to the horizontal direction of the real space, the y axis thereof is parallel to the vertical direction of the real space, and the z axis thereof is parallel to the front-rear direction of the real space.

In at least one aspect, the HMD sensor 410 includes an infrared sensor. When the infrared sensor detects the infrared ray emitted from each light source of the HMD 120, the infrared sensor detects the presence of the HMD 120. The HMD sensor 410 further detects the position and the inclination (direction) of the HMD 120 in the real space, which corresponds to the motion of the user 5 wearing the HMD 120, based on the value of each point (each coordinate value in the real coordinate system). In more detail, the HMD sensor 410 is able to detect the temporal change of the position and the inclination of the HMD 120 with use of each value detected over time.

Each inclination of the HMD 120 detected by the HMD sensor 410 corresponds to an inclination about each of the three axes of the HMD 120 in the real coordinate system. The HMD sensor 410 sets a uvw visual-field coordinate system to the HMD 120 based on the inclination of the HMD 120 in the real coordinate system. The uvw visual-field coordinate system set to the HMD 120 corresponds to a point-of-view coordinate system used when the user 5 wearing the HMD 120 views an object in the virtual space.

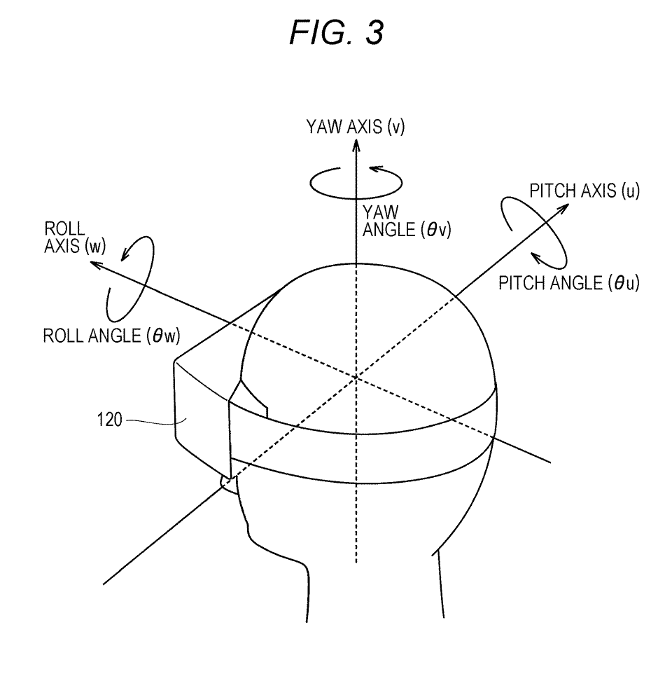

With reference to FIG. 3, the uvw visual-field coordinate system is described according to at least one embodiment. FIG. 3 is a diagram of a uvw visual-field coordinate system to be set for the HMD 120 according to at least one embodiment of this disclosure. The HMD sensor 410 detects the position and the inclination of the HMD 120 in the real coordinate system when the HMD 120 is activated. The processor 210 sets the uvw visual-field coordinate system to the HMD 120 based on the detected values.

In FIG. 3, the HMD 120 sets the three-dimensional uvw visual-field coordinate system defining the head of the user 5 wearing the HMD 120 as a center (origin). More specifically, the HMD 120 sets three directions newly obtained by inclining the horizontal direction, the vertical direction, and the front-rear direction (x axis, y axis, and z axis), which define the real coordinate system, about the respective axes by the inclinations about the respective axes of the HMD 120 in the real coordinate system, as a pitch axis (u axis), a yaw axis (v axis), and a roll axis (w axis) of the uvw visual-field coordinate system in the HMD 120.

In at least one aspect, when the user 5 wearing the HMD 120 is standing (or sitting) upright and is visually recognizing the front side, the processor 210 sets the uvw visual-field coordinate system that is parallel to the real coordinate system to the HMD 120. In this case, the horizontal direction (x axis), the vertical direction (y axis), and the front-rear direction (z axis) of the real coordinate system directly match the pitch axis (u axis), the yaw axis (v axis), and the roll axis (w axis) of the uvw visual-field coordinate system in the HMD 120, respectively.

After the uvw visual-field coordinate system is set to the HMD 120, the HMD sensor 410 is able to detect the inclination of the HMD 120 in the set uvw visual-field coordinate system based on the motion of the HMD 120. In this case, the HMD sensor 410 detects, as the inclination of the HMD 120, each of a pitch angle (θu), a yaw angle (θv), and a roll angle (θw) of the HMD 120 in the uvw visual-field coordinate system. The pitch angle (θu) represents an inclination angle of the HMD 120 about the pitch axis in the uvw visual-field coordinate system. The yaw angle (θv) represents an inclination angle of the HMD 120 about the yaw axis in the uvw visual-field coordinate system. The roll angle (θw) represents an inclination angle of the HMD 120 about the roll axis in the uvw visual-field coordinate system.

The HMD sensor 410 sets, to the HMD 120, the uvw visual-field coordinate system of the HMD 120 obtained after the movement of the HMD 120 based on the detected inclination angle of the HMD 120. The relationship between the HMD 120 and the uvw visual-field coordinate system of the HMD 120 is constant regardless of the position and the inclination of the HMD 120. When the position and the inclination of the HMD 120 change, the position and the inclination of the uvw visual-field coordinate system of the HMD 120 in the real coordinate system change in synchronization with the change of the position and the inclination.

In at least one aspect, the HMD sensor 410 identifies the position of the HMD 120 in the real space as a position relative to the HMD sensor 410 based on the light intensity of the infrared ray or a relative positional relationship between a plurality of points (e.g., distance between points), which is acquired based on output from the infrared sensor. In at least one aspect, the processor 210 determines the origin of the uvw visual-field coordinate system of the HMD 120 in the real space (real coordinate system) based on the identified relative position.

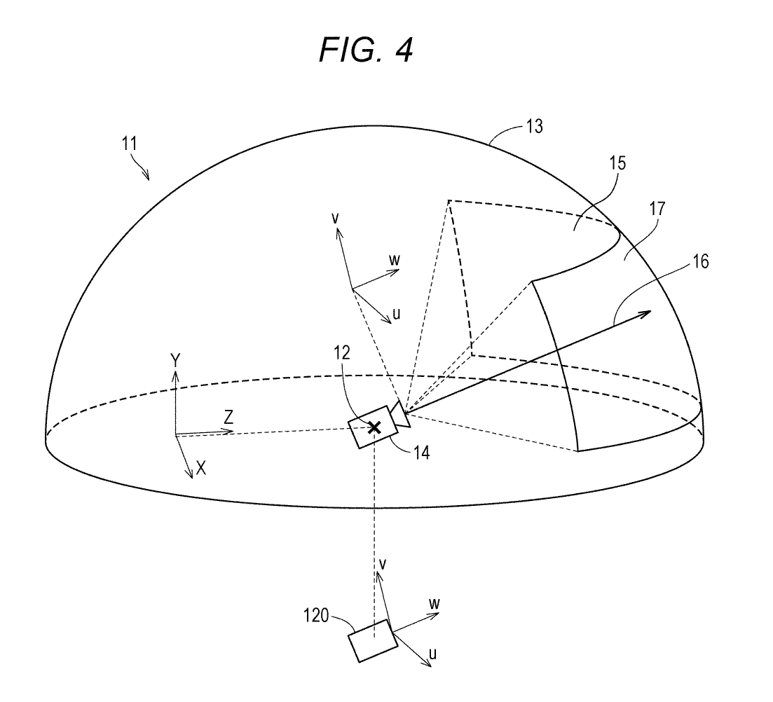

With reference to FIG. 4, the virtual space is further described according to at least one embodiment. FIG. 4 is a diagram of a mode of expressing a virtual space 11 according to at least one embodiment of this disclosure. The virtual space 11 has a structure with an entire celestial sphere shape covering a center 12 in all 360-degree directions. In FIG. 4, for the sake of clarity, only the upper-half celestial sphere of the virtual space 11 is included. Each mesh section is defined in the virtual space 11. The position of each mesh section is defined in advance as coordinate values in an XYZ coordinate system, which is a global coordinate system defined in the virtual space 11. The computer 200 associates each partial image forming a panorama image 13 (e.g., still image or moving image) that is developed in the virtual space 11 with each corresponding mesh section in the virtual space 11.

In at least one aspect, in the virtual space 11, the XYZ coordinate system having the center 12 as the origin is defined. The XYZ coordinate system is, for example, parallel to the real coordinate system. The horizontal direction, the vertical direction (up-down direction), and the front-rear direction of the XYZ coordinate system are defined as an X axis, a Y axis, and a Z axis, respectively. Thus, the X axis (horizontal direction) of the XYZ coordinate system is parallel to the x axis of the real coordinate system, the Y axis (vertical direction) of the XYZ coordinate system is parallel to the y axis of the real coordinate system, and the Z axis (front-rear direction) of the XYZ coordinate system is parallel to the z axis of the real coordinate system.

When the HMD 120 is activated, that is, when the HMD 120 is in an initial state, a virtual camera 14 is arranged at the center 12 of the virtual space 11. In at least one embodiment, the virtual camera 14 is offset from the center 12 in the initial state. In at least one aspect, the processor 210 displays on the monitor 130 of the HMD 120 an image photographed by the virtual camera 14. In synchronization with the motion of the HMD 120 in the real space, the virtual camera 14 similarly moves in the virtual space 11. With this, the change in position and direction of the HMD 120 in the real space is reproduced similarly in the virtual space 11.

The uvw visual-field coordinate system is defined in the virtual camera 14 similarly to the case of the HMD 120. The uvw visual-field coordinate system of the virtual camera 14 in the virtual space 11 is defined to be synchronized with the uvw visual-field coordinate system of the HMD 120 in the real space (real coordinate system). Therefore, when the inclination of the HMD 120 changes, the inclination of the virtual camera 14 also changes in synchronization therewith. The virtual camera 14 can also move in the virtual space 11 in synchronization with the movement of the user 5 wearing the HMD 120 in the real space.

The processor 210 of the computer 200 defines a field-of-view region 15 in the virtual space 11 based on the position and inclination (reference line of sight 16) of the virtual camera 14. The field-of-view region 15 corresponds to, of the virtual space 11, the region that is visually recognized by the user 5 wearing the HMD 120. That is, the position of the virtual camera 14 determines a point of view of the user 5 in the virtual space 11.

The line of sight of the user 5 detected by the eye gaze sensor 140 is a direction in the point-of-view coordinate system obtained when the user 5 visually recognizes an object. The uvw visual-field coordinate system of the HMD 120 is equal to the point-of-view coordinate system used when the user 5 visually recognizes the monitor 130. The uvw visual-field coordinate system of the virtual camera 14 is synchronized with the uvw visual-field coordinate system of the HMD 120. Therefore, in the system 100 in at least one aspect, the line of sight of the user 5 detected by the eye gaze sensor 140 can be regarded as the line of sight of the user 5 in the uvw visual-field coordinate system of the virtual camera 14.

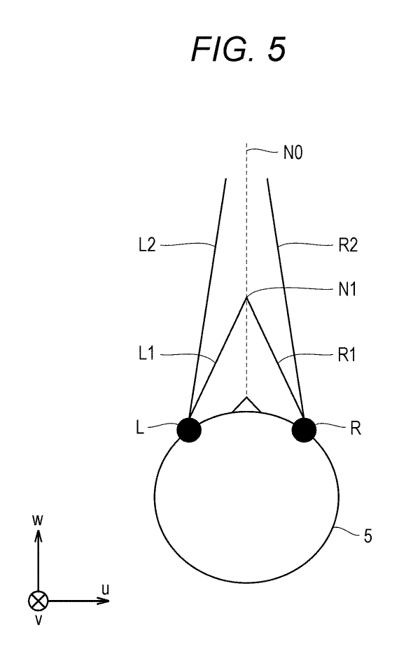

With reference to FIG. 5, determination of the line of sight of the user 5 is described according to at least one embodiment. FIG. 5 is a plan view diagram of the head of the user 5 wearing the HMD 120 according to at least one embodiment of this disclosure.

In at least one aspect, the eye gaze sensor 140 detects lines of sight of the right eye and the left eye of the user 5. In at least one aspect, when the user 5 is looking at a near place, the eye gaze sensor 140 detects lines of sight R1 and L1. In at least one aspect, when the user 5 is looking at a far place, the eye gaze sensor 140 detects lines of sight R2 and L2. In this case, the angles formed by the lines of sight R2 and L2 with respect to the roll axis w are smaller than the angles formed by the lines of sight R1 and L1 with respect to the roll axis w. The eye gaze sensor 140 transmits the detection results to the computer 200.

When the computer 200 receives the detection values of the lines of sight R1 and L1 from the eye gaze sensor 140 as the detection results of the lines of sight, the computer 200 identifies a point of gaze N1 being an intersection of both the lines of sight R1 and L1 based on the detection values. Meanwhile, when the computer 200 receives the detection values of the lines of sight R2 and L2 from the eye gaze sensor 140, the computer 200 identifies an intersection of both the lines of sight R2 and L2 as the point of gaze. The computer 200 identifies a line of sight N0 of the user 5 based on the identified point of gaze N1. The computer 200 detects, for example, an extension direction of a straight line that passes through the point of gaze N1 and a midpoint of a straight line connecting a right eye R and a left eye L of the user 5 to each other as the line of sight N0. The line of sight N0 is a direction in which the user 5 actually directs his or her lines of sight with both eyes. The line of sight N0 corresponds to a direction in which the user 5 actually directs his or her lines of sight with respect to the field-of-view region 15.

In at least one aspect, the system 100 includes a television broadcast reception tuner. With such a configuration, the system 100 is able to display a television program in the virtual space 11.

In at least one aspect, the HMD system 100 includes a communication circuit for connecting to the Internet or has a verbal communication function for connecting to a telephone line or a cellular service.

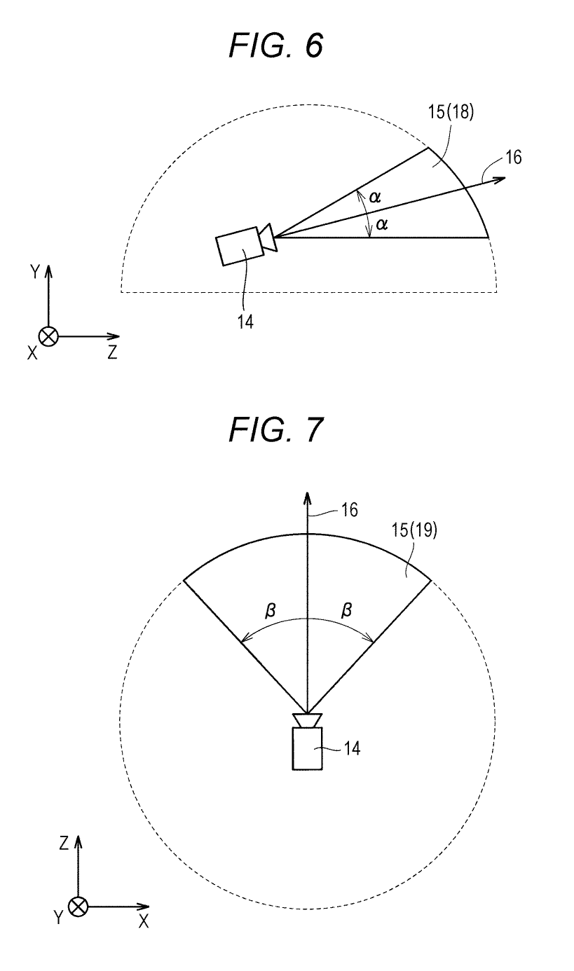

With reference to FIG. 6 and FIG. 7, the field-of-view region 15 is described according to at least one embodiment. FIG. 6 is a diagram of a YZ cross section obtained by viewing the field-of-view region 15 from an X direction in the virtual space 11. FIG. 7 is a diagram of an XZ cross section obtained by viewing the field-of-view region 15 from a Y direction in the virtual space 11.

In FIG. 6, the field-of-view region 15 in the YZ cross section includes a region 18. The region 18 is defined by the position of the virtual camera 14, the reference line of sight 16, and the YZ cross section of the virtual space 11. The processor 210 defines a range of a polar angle α from the reference line of sight 16 serving as the center in the virtual space as the region 18.

In FIG. 7, the field-of-view region 15 in the XZ cross section includes a region 19. The region 19 is defined by the position of the virtual camera 14, the reference line of sight 16, and the XZ cross section of the virtual space 11. The processor 210 defines a range of an azimuth β from the reference line of sight 16 serving as the center in the virtual space 11 as the region 19. The polar angle α and β are determined in accordance with the position of the virtual camera 14 and the inclination (direction) of the virtual camera 14.

In at least one aspect, the system 100 causes the monitor 130 to display a field-of-view image 17 based on the signal from the computer 200, to thereby provide the field of view in the virtual space 11 to the user 5. The field-of-view image 17 corresponds to a part of the panorama image 13, which corresponds to the field-of-view region 15. When the user 5 moves the HMD 120 worn on his or her head, the virtual camera 14 is also moved in synchronization with the movement. As a result, the position of the field-of-view region 15 in the virtual space 11 is changed. With this, the field-of-view image 17 displayed on the monitor 130 is updated to an image of the panorama image 13, which is superimposed on the field-of-view region 15 synchronized with a direction in which the user 5 faces in the virtual space 11. The user 5 can visually recognize a desired direction in the virtual space 11.

In this way, the inclination of the virtual camera 14 corresponds to the line of sight of the user 5 (reference line of sight 16) in the virtual space 11, and the position at which the virtual camera 14 is arranged corresponds to the point of view of the user 5 in the virtual space 11. Therefore, through the change of the position or inclination of the virtual camera 14, the image to be displayed on the monitor 130 is updated, and the field of view of the user 5 is moved.

While the user 5 is wearing the HMD 120 (having a non-transmissive monitor 130), the user 5 can visually recognize only the panorama image 13 developed in the virtual space 11 without visually recognizing the real world. Therefore, the system 100 provides a high sense of immersion in the virtual space 11 to the user 5.

In at least one aspect, the processor 210 moves the virtual camera 14 in the virtual space 11 in synchronization with the movement in the real space of the user 5 wearing the HMD 120. In this case, the processor 210 identifies an image region to be projected on the monitor 130 of the HMD 120 (field-of-view region 15) based on the position and the direction of the virtual camera 14 in the virtual space 11.

In at least one aspect, the virtual camera 14 includes two virtual cameras, that is, a virtual camera for providing a right-eye image and a virtual camera for providing a left-eye image. An appropriate parallax is set for the two virtual cameras so that the user 5 is able to recognize the three-dimensional virtual space 11. In at least one aspect, the virtual camera 14 is implemented by a single virtual camera. In this case, a right-eye image and a left-eye image may be generated from an image acquired by the single virtual camera. In at least one embodiment, the virtual camera 14 is assumed to include two virtual cameras, and the roll axes of the two virtual cameras are synthesized so that the generated roll axis (w) is adapted to the roll axis (w) of the HMD 120.

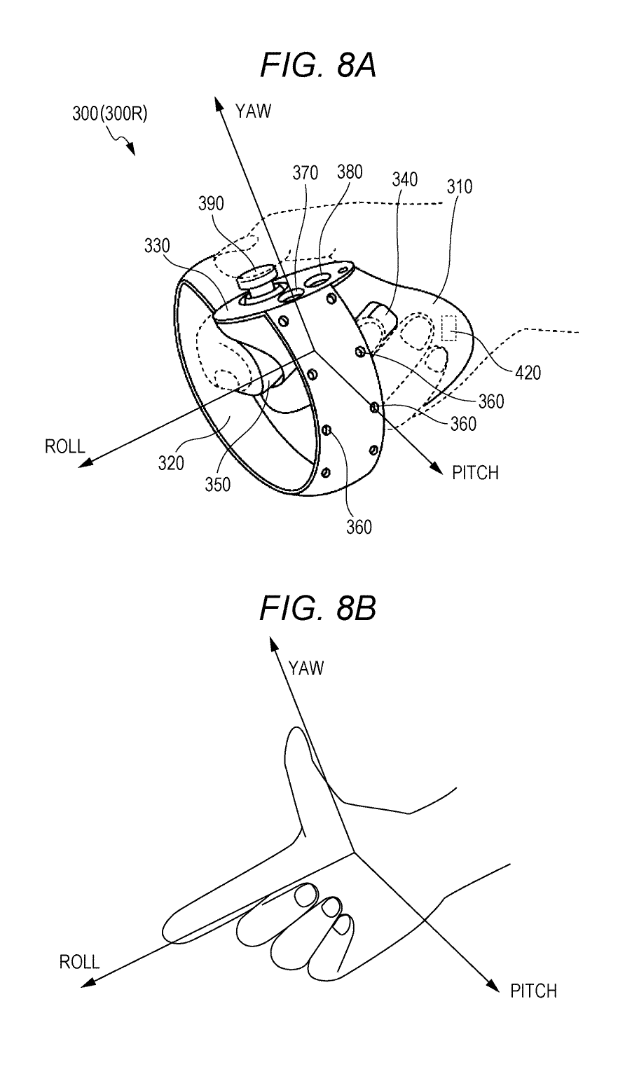

At least one example of the controller 300 is described with reference to FIG. 8A and FIG. 8B. FIG. 8A is a diagram of a schematic configuration of a controller according to at least one embodiment of this disclosure. FIG. 8B is a diagram of a coordinate system to be set for a hand of a user holding the controller according to at least one embodiment of this disclosure.

In at least one aspect, the controller 300 includes a right controller 300R and a left controller (not shown). In FIG. 8A only right controller 300R is shown for the sake of clarity. The right controller 300R is operable by the right hand of the user 5. The left controller is operable by the left hand of the user 5. In at least one aspect, the right controller 300R and the left controller are symmetrically configured as separate devices. Therefore, the user 5 can freely move his or her right hand holding the right controller 300R and his or her left hand holding the left controller. In at least one aspect, the controller 300 may be an integrated controller configured to receive an operation performed by both the right and left hands of the user 5. The right controller 300R is now described.

The right controller 300R includes a grip 310, a frame 320, and a top surface 330. The grip 310 is configured so as to be held by the right hand of the user 5. For example, the grip 310 may be held by the palm and three fingers (e.g., middle finger, ring finger, and small finger) of the right hand of the user 5.

The grip 310 includes buttons 340 and 350 and the motion sensor 420. The button 340 is arranged on a side surface of the grip 310, and receives an operation performed by, for example, the middle finger of the right hand. The button 350 is arranged on a front surface of the grip 310, and receives an operation performed by, for example, the index finger of the right hand. In at least one aspect, the buttons 340 and 350 are configured as trigger type buttons. The motion sensor 420 is built into the casing of the grip 310. When a motion of the user 5 can be detected from the surroundings of the user 5 by a camera or other device. In at least one embodiment, the grip 310 does not include the motion sensor 420.

The frame 320 includes a plurality of infrared LEDs 360 arranged in a circumferential direction of the frame 320. The infrared LEDs 360 emit, during execution of a program using the controller 300, infrared rays in accordance with progress of the program. The infrared rays emitted from the infrared LEDs 360 are usable to independently detect the position and the posture (inclination and direction) of each of the right controller 300R and the left controller. In FIG. 8A, the infrared LEDs 360 are shown as being arranged in two rows, but the number of arrangement rows is not limited to that illustrated in FIG. 8. In at least one embodiment, the infrared LEDs 360 are arranged in one row or in three or more rows. In at least one embodiment, the infrared LEDs 360 are arranged in a pattern other than rows.

The top surface 330 includes buttons 370 and 380 and an analog stick 390. The buttons 370 and 380 are configured as push type buttons. The buttons 370 and 380 receive an operation performed by the thumb of the right hand of the user 5. In at least one aspect, the analog stick 390 receives an operation performed in any direction of 360 degrees from an initial position (neutral position). The operation includes, for example, an operation for moving an object arranged in the virtual space 11.

In at least one aspect, each of the right controller 300R and the left controller includes a battery for driving the infrared ray LEDs 360 and other members. The battery includes, for example, a rechargeable battery, a button battery, a dry battery, but the battery is not limited thereto. In at least one aspect, the right controller 300R and the left controller are connectable to, for example, a USB interface of the computer 200. In at least one embodiment, the right controller 300R and the left controller do not include a battery.

In FIG. 8A and FIG. 8B, for example, a yaw direction, a roll direction, and a pitch direction are defined with respect to the right hand of the user 5. A direction of an extended thumb is defined as the yaw direction, a direction of an extended index finger is defined as the roll direction, and a direction perpendicular to a plane is defined as the pitch direction.

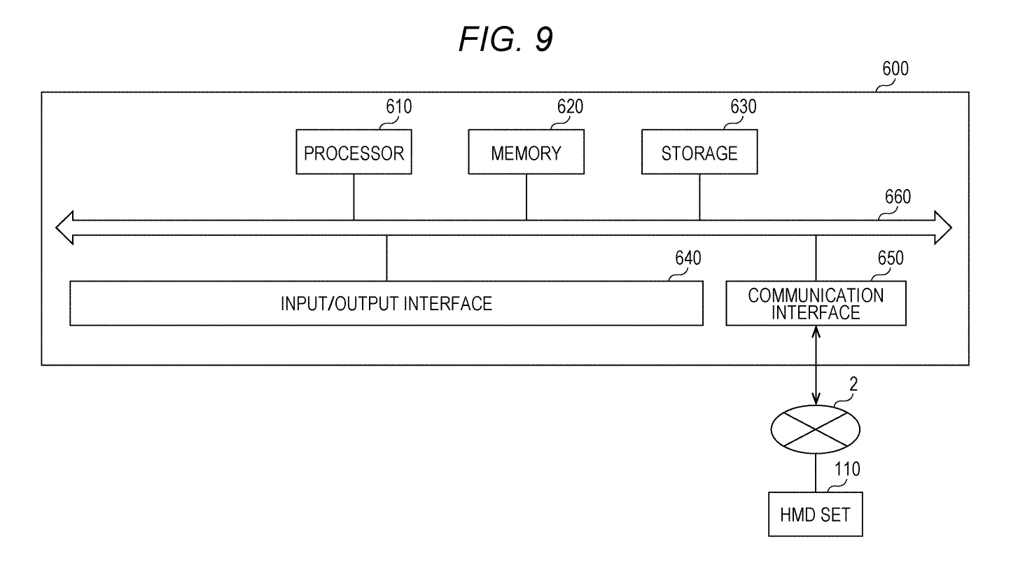

With reference to FIG. 9, the server 600 in at least one embodiment is described according to at least one embodiment. FIG. 9 is a block diagram of a hardware configuration of the server 600 according to at least one embodiment of this disclosure. The server 600 includes a processor 610, a memory 620, a storage 630, an input/output interface 640, and a communication interface 650. Each component is connected to a bus 660. In at least one embodiment, at least one of the processor 610, the memory 620, the storage 630, the input/output interface 640 or the communication interface 650 is part of a separate structure and communicates with other components of server 600 through a communication path other than the bus 660.

The processor 610 executes a series of commands included in a program stored in the memory 620 or the storage 630 based on a signal transmitted to the server 600 or on satisfaction of a condition determined in advance. In at least one aspect, the processor 610 is implemented as a central processing unit (CPU), a graphics processing unit (GPU), a micro processing unit (MPU), a field-programmable gate array (FPGA), or other devices.

The memory 620 stores programs and data. In at least one embodiment, memory 620 stores programs and data during operation of the server 600. The programs are loaded from, for example, the storage 630. The data includes data input to the server 600 and data generated by the processor 610. In at least one aspect, the memory 620 is implemented as a random access memory (RAM) or other volatile memories.

The storage 630 stores programs and data. In at least one embodiment, the storage 630 stores programs and data even when the server 600 is not in operation. In at least one embodiment, the storage 630 stores programs and data for a period of time longer than the memory 620. The storage 630 is implemented as, for example, a read-only memory (ROM), a hard disk device, a flash memory, or other non-volatile storage devices. The programs stored in the storage 630 include programs for providing a virtual space in the system 100, simulation programs, game programs, user authentication programs, and programs for implementing communication to/from other computers 200 or servers 600. The data stored in the storage 630 may include, for example, data and objects for defining the virtual space.

In at least one aspect, the storage 630 is implemented as a removable storage device, such as a memory card. In at least one aspect, a configuration that uses programs and data stored in an external storage device is used instead of the storage 630 built into the server 600. With such a configuration, for example, in a situation in which a plurality of HMD systems 100 are used, for example, as in an amusement facility, the programs and the data are collectively updated.

The input/output interface 640 allows communication of signals to/from an input/output device. In at least one aspect, the input/output interface 640 is implemented with use of a USB, a DVI, an HDMI, or other terminals. The input/output interface 640 is not limited to the specific examples described above.

The communication interface 650 is connected to the network 2 to communicate to/from the computer 200 connected to the network 2. In at least one aspect, the communication interface 650 is implemented as, for example, a LAN, other wired communication interfaces, Wi-H, Bluetooth, NFC, or other wireless communication interfaces. The communication interface 650 is not limited to the specific examples described above.

In at least one aspect, the processor 610 accesses the storage 630 and loads one or more programs stored in the storage 630 to the memory 620 to execute a series of commands included in the program. In at least one embodiment, the one or more programs include, for example, an operating system of the server 600, an application program for providing a virtual space, and game software that can be executed in the virtual space. In at least one embodiment, the processor 610 transmits a signal for providing a virtual space to the HMD device 110 to the computer 200 via the input/output interface 640.

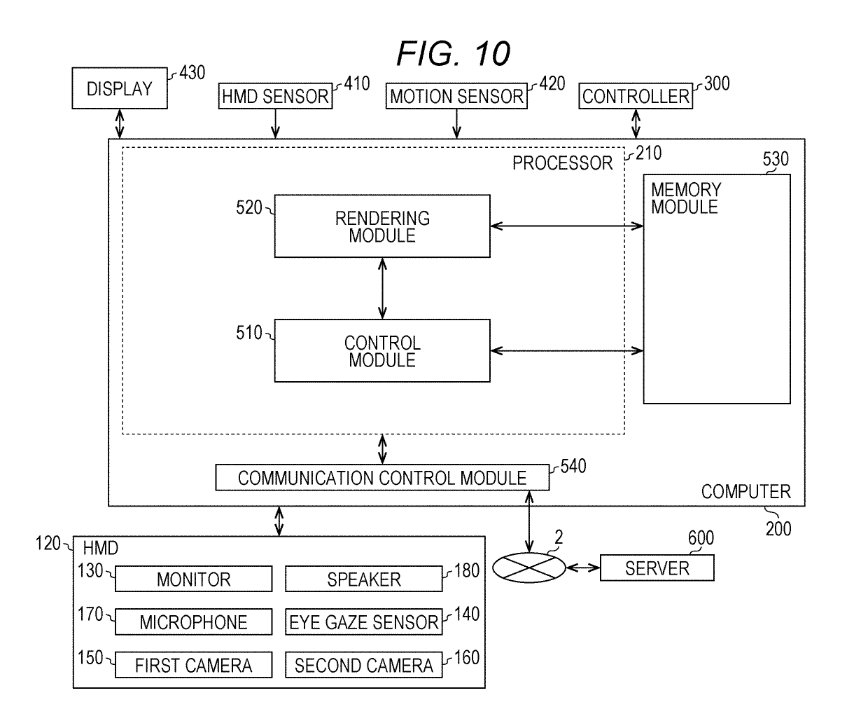

With reference to FIG. 10, the control device of the HMD 120 is described according to at least one embodiment. According to at least one embodiment of this disclosure, the control device is implemented by the computer 200 having a known configuration. FIG. 10 is a block diagram of the computer 200 according to at least one embodiment of this disclosure. FIG. 10 includes a module configuration of the computer 200.

In FIG. 10, the computer 200 includes a control module 510, a rendering module 520, a memory module 530, and a communication control module 540. In at least one aspect, the control module 510 and the rendering module 520 are implemented by the processor 210. In at least one aspect, a plurality of processors 210 function as the control module 510 and the rendering module 520. The memory module 530 is implemented by the memory 220 or the storage 230. The communication control module 540 is implemented by the communication interface 250.

The control module 510 controls the virtual space 11 provided to the user 5. The control module 510 defines the virtual space 11 in the HMD system 100 using virtual space data representing the virtual space 11. The virtual space data is stored in, for example, the memory module 530. In at least one embodiment, the control module 510 generates virtual space data. In at least one embodiment, the control module 510 acquires virtual space data from, for example, the server 600.

The control module 510 arranges objects in the virtual space 11 using object data representing objects. The object data is stored in, for example, the memory module 530. In at least one embodiment, the control module 510 generates virtual space data. In at least one embodiment, the control module 510 acquires virtual space data from, for example, the server 600. In at least one embodiment, the objects include, for example, an avatar object of the user 5, character objects, operation objects, for example, a virtual hand to be operated by the controller 300, and forests, mountains, other landscapes, streetscapes, or animals to be arranged in accordance with the progression of the story of the game.

The control module 510 arranges an avatar object of the user 5 of another computer 200, which is connected via the network 2, in the virtual space 11. In at least one aspect, the control module 510 arranges an avatar object of the user 5 in the virtual space 11. In at least one aspect, the control module 510 arranges an avatar object simulating the user 5 in the virtual space 11 based on an image including the user 5. In at least one aspect, the control module 510 arranges an avatar object in the virtual space 11, which is selected by the user 5 from among a plurality of types of avatar objects (e.g., objects simulating animals or objects of deformed humans).

The control module 510 identifies an inclination of the HMD 120 based on output of the HMD sensor 410. In at least one aspect, the control module 510 identifies an inclination of the HMD 120 based on output of the sensor 190 functioning as a motion sensor. The control module 510 detects parts (e.g., mouth, eyes, and eyebrows) forming the face of the user 5 from a face image of the user 5 generated by the first camera 150 and the second camera 160. The control module 510 detects a motion (shape) of each detected part.

The control module 510 detects a line of sight of the user 5 in the virtual space 11 based on a signal from the eye gaze sensor 140. The control module 510 detects a point-of-view position (coordinate values in the XYZ coordinate system) at which the detected line of sight of the user 5 and the celestial sphere of the virtual space 11 intersect with each other. More specifically, the control module 510 detects the point-of-view position based on the line of sight of the user 5 defined in the uvw coordinate system and the position and the inclination of the virtual camera 14. The control module 510 transmits the detected point-of-view position to the server 600. In at least one aspect, the control module 510 is configured to transmit line-of-sight information representing the line of sight of the user 5 to the server 600. In such a case, the control module 510 may calculate the point-of-view position based on the line-of-sight information received by the server 600.

The control module 510 translates a motion of the HMD 120, which is detected by the HMD sensor 410, in an avatar object. For example, the control module 510 detects inclination of the HMD 120, and arranges the avatar object in an inclined manner. The control module 510 translates the detected motion of face parts in a face of the avatar object arranged in the virtual space 11. The control module 510 receives line-of-sight information of another user 5 from the server 600, and translates the line-of-sight information in the line of sight of the avatar object of another user 5. In at least one aspect, the control module 510 translates a motion of the controller 300 in an avatar object and an operation object. In this case, the controller 300 includes, for example, a motion sensor, an acceleration sensor, or a plurality of light emitting elements (e.g., infrared LEDs) for detecting a motion of the controller 300.

The control module 510 arranges, in the virtual space 11, an operation object for receiving an operation by the user 5 in the virtual space 11. The user 5 operates the operation object to, for example, operate an object arranged in the virtual space 11. In at least one aspect, the operation object includes, for example, a hand object serving as a virtual hand corresponding to a hand of the user 5. In at least one aspect, the control module 510 moves the hand object in the virtual space 11 so that the hand object moves in association with a motion of the hand of the user 5 in the real space based on output of the motion sensor 420. In at least one aspect, the operation object may correspond to a hand part of an avatar object.

When one object arranged in the virtual space 11 collides with another object, the control module 510 detects the collision. The control module 510 is able to detect, for example, a timing at which a collision area of one object and a collision area of another object have touched with each other, and performs predetermined processing in response to the detected timing. In at least one embodiment, the control module 510 detects a timing at which an object and another object, which have been in contact with each other, have moved away from each other, and performs predetermined processing in response to the detected timing. In at least one embodiment, the control module 510 detects a state in which an object and another object are in contact with each other. For example, when an operation object touches another object, the control module 510 detects the fact that the operation object has touched the other object, and performs predetermined processing.

In at least one aspect, the control module 510 controls image display of the HMD 120 on the monitor 130. For example, the control module 510 arranges the virtual camera 14 in the virtual space 11. The control module 510 controls the position of the virtual camera 14 and the inclination (direction) of the virtual camera 14 in the virtual space 11. The control module 510 defines the field-of-view region 15 depending on an inclination of the head of the user 5 wearing the HMD 120 and the position of the virtual camera 14. The rendering module 520 generates the field-of-view region 17 to be displayed on the monitor 130 based on the determined field-of-view region 15. The communication control module 540 outputs the field-of-view region 17 generated by the rendering module 520 to the HMD 120.

The control module 510, which has detected an utterance of the user 5 using the microphone 170 from the HMD 120, identifies the computer 200 to which voice data corresponding to the utterance is to be transmitted. The voice data is transmitted to the computer 200 identified by the control module 510. The control module 510, which has received voice data from the computer 200 of another user via the network 2, outputs audio information (utterances) corresponding to the voice data from the speaker 180.

The memory module 530 holds data to be used to provide the virtual space 11 to the user 5 by the computer 200. In at least one aspect, the memory module 530 stores space information, object information, and user information.

The space information stores one or more templates defined to provide the virtual space 11.

The object information stores a plurality of panorama images 13 forming the virtual space 11 and object data for arranging objects in the virtual space 11. In at least one embodiment, the panorama image 13 contains a still image and/or a moving image. In at least one embodiment, the panorama image 13 contains an image in a non-real space and/or an image in the real space. An example of the image in a non-real space is an image generated by computer graphics.

The user information stores a user ID for identifying the user 5. The user ID is, for example, an internet protocol (IP) address or a media access control (MAC) address set to the computer 200 used by the user. In at least one aspect, the user ID is set by the user. The user information stores, for example, a program for causing the computer 200 to function as the control device of the HMD system 100.

The data and programs stored in the memory module 530 are input by the user 5 of the HMD 120. Alternatively, the processor 210 downloads the programs or data from a computer (e.g., server 600) that is managed by a business operator providing the content, and stores the downloaded programs or data in the memory module 530.

In at least one embodiment, the communication control module 540 communicates to/from the server 600 or other information communication devices via the network 2.

In at least one aspect, the control module 510 and the rendering module 520 are implemented with use of, for example, Unity® provided by Unity Technologies. In at least one aspect, the control module 510 and the rendering module 520 are implemented by combining the circuit elements for implementing each step of processing.

The processing performed in the computer 200 is implemented by hardware and software executed by the processor 410. In at least one embodiment, the software is stored in advance on a hard disk or other memory module 530. In at least one embodiment, the software is stored on a CD-ROM or other computer-readable non-volatile data recording media, and distributed as a program product. In at least one embodiment, the software may be provided as a program product that is downloadable by an information provider connected to the Internet or other networks. Such software is read from the data recording medium by an optical disc drive device or other data reading devices, or is downloaded from the server 600 or other computers via the communication control module 540 and then temporarily stored in a storage module. The software is read from the storage module by the processor 210, and is stored in a RAM in a format of an executable program. The processor 210 executes the program.

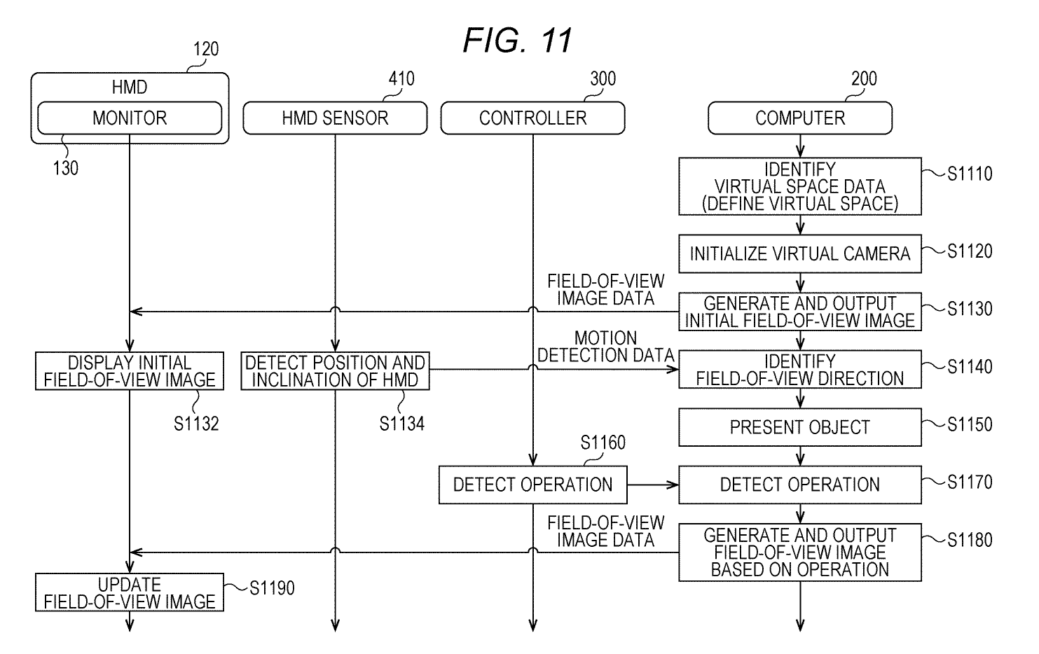

With reference to FIG. 11, the control structure of the HMD set 110 is described. FIG. 11 is a flowchart of processing to be executed by the system 100 according to at least one embodiment of this disclosure.

In FIG. 11, in Step S1110, the processor 210 of the computer 200 serves as the control module 510 to identify virtual space data and define the virtual space 11.

In Step S1120, the processor 210 initializes the virtual camera 14. For example, in a work area of the memory, the processor 210 arranges the virtual camera 14 at the center 12 defined in advance in the virtual space 11, and matches the line of sight of the virtual camera 14 with the direction in which the user 5 faces.

In Step S1130, the processor 210 serves as the rendering module 520 to generate field-of-view image data for displaying an initial field-of-view image. The generated field-of-view image data is output to the HMD 120 by the communication control module 540.

In Step S1132, the monitor 130 of the HMD 120 displays the field-of-view image based on the field-of-view image data received from the computer 200. The user 5 wearing the HMD 120 is able to recognize the virtual space 11 through visual recognition of the field-of-view image.

In Step S1134, the HMD sensor 410 detects the position and the inclination of the HMD 120 based on a plurality of infrared rays emitted from the HMD 120. The detection results are output to the computer 200 as motion detection data.

In Step S1140, the processor 210 identifies a field-of-view direction of the user 5 wearing the HMD 120 based on the position and inclination contained in the motion detection data of the HMD 120.

In Step S1150, the processor 210 executes an application program, and arranges an object in the virtual space 11 based on a command contained in the application program.

In Step S1160, the controller 300 detects an operation by the user 5 based on a signal output from the motion sensor 420, and outputs detection data representing the detected operation to the computer 200. In at least one aspect, an operation of the controller 300 by the user 5 is detected based on an image from a camera arranged around the user 5.

In Step S1170, the processor 210 detects an operation of the controller 300 by the user 5 based on the detection data acquired from the controller 300.

In Step S1180, the processor 210 generates field-of-view image data based on the operation of the controller 300 by the user 5. The communication control module 540 outputs the generated field-of-view image data to the HMD 120.

In Step S1190, the HMD 120 updates a field-of-view image based on the received field-of-view image data, and displays the updated field-of-view image on the monitor 130.

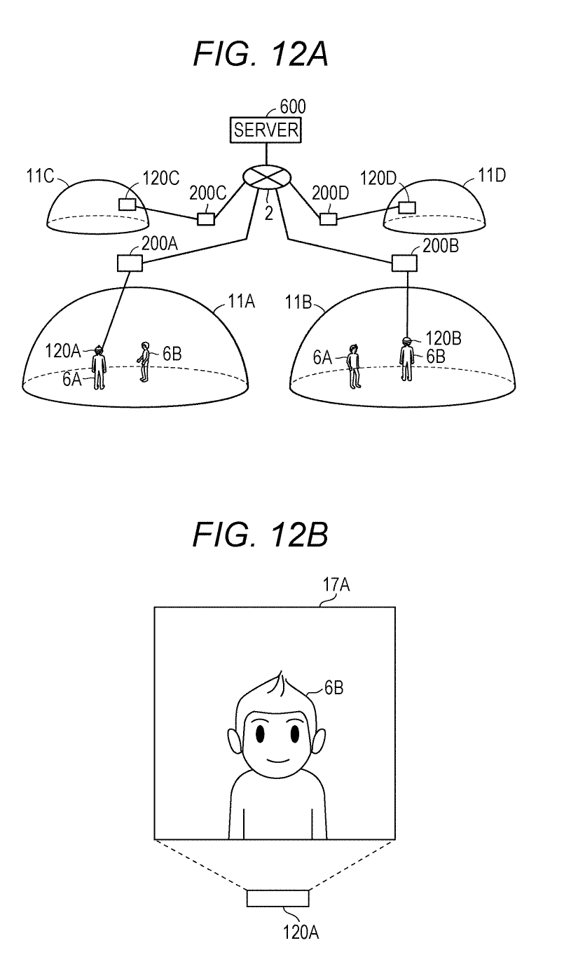

With reference to FIG. 12A and FIG. 12B, an avatar object according to at least one embodiment is described. FIG. 12 and FIG. 12B are diagrams of avatar objects of respective users 5 of the HMD sets 110A and 110B. In the following, the user of the HMD set 110A, the user of the HMD set 110B, the user of the HMD set 110C, and the user of the HMD set 110D are referred to as “user 5A”, “user 5B”, “user 5C”, and “user 5D”, respectively. A reference numeral of each component related to the HMD set 110A, a reference numeral of each component related to the HMD set 110B, a reference numeral of each component related to the HMD set 110C, and a reference numeral of each component related to the HMD set 110D are appended by A, B, C, and D, respectively. For example, the HMD 120A is included in the HMD set 110A.

FIG. 12A is a schematic diagram of HMD systems of several users sharing the virtual space interact using a network according to at least one embodiment of this disclosure. Each HMD 120 provides the user 5 with the virtual space 11. Computers 200A to 200D provide the users 5A to 5D with virtual spaces 11A to 11D via HMDs 120A to 120D, respectively. In FIG. 12A, the virtual space 11A and the virtual space 11B are formed by the same data. In other words, the computer 200A and the computer 200B share the same virtual space. An avatar object 6A of the user 5A and an avatar object 6B of the user 5B are present in the virtual space 11A and the virtual space 11B. The avatar object 6A in the virtual space 11A and the avatar object 6B in the virtual space 11B each wear the HMD 120. However, the inclusion of the HMD 120A and HMD 120B is only for the sake of simplicity of description, and one of ordinary skill in the art would understand that the avatars do not wear the HMD 120A and HMD 120B in the virtual spaces 11A and 11B, respectively.

In at least one aspect, the processor 210A arranges a virtual camera 14A for photographing a field-of-view region 17A of the user 5A at the position of eyes of the avatar object 6A.

FIG. 12B is a diagram of a field of view of a HMD according to at least one embodiment of this disclosure. FIG. 12(B) corresponds to the field-of-view region 17A of the user 5A in FIG. 12A. The field-of-view region 17A is an image displayed on a monitor 130A of the HMD 120A. This field-of-view region 17A is an image generated by the virtual camera 14A. The avatar object 6B of the user 5B is displayed in the field-of-view region 17A. Although not included in FIG. 12B for the sake of simplicity, the avatar object 6A of the user 5A is displayed in the field-of-view image of the user 5B.

In the arrangement in FIG. 12B, the user 5A can communicate to/from the user 5B via the virtual space 11A through conversation. More specifically, voices of the user 5A acquired by a microphone 170A are transmitted to the HMD 120B of the user 5B via the server 600 and output from a speaker 180B provided on the HMD 120B. Voices of the user 5B are transmitted to the HMD 120A of the user 5A via the server 600, and output from a speaker 180A provided on the HMD 120A.

The processor 210A translates an operation by the user 5B (operation of HMD 120B and operation of controller 300B) in the avatar object 6B arranged in the virtual space 11A. With this, the user 5A is able to recognize the operation by the user 5B through the avatar object 6B.

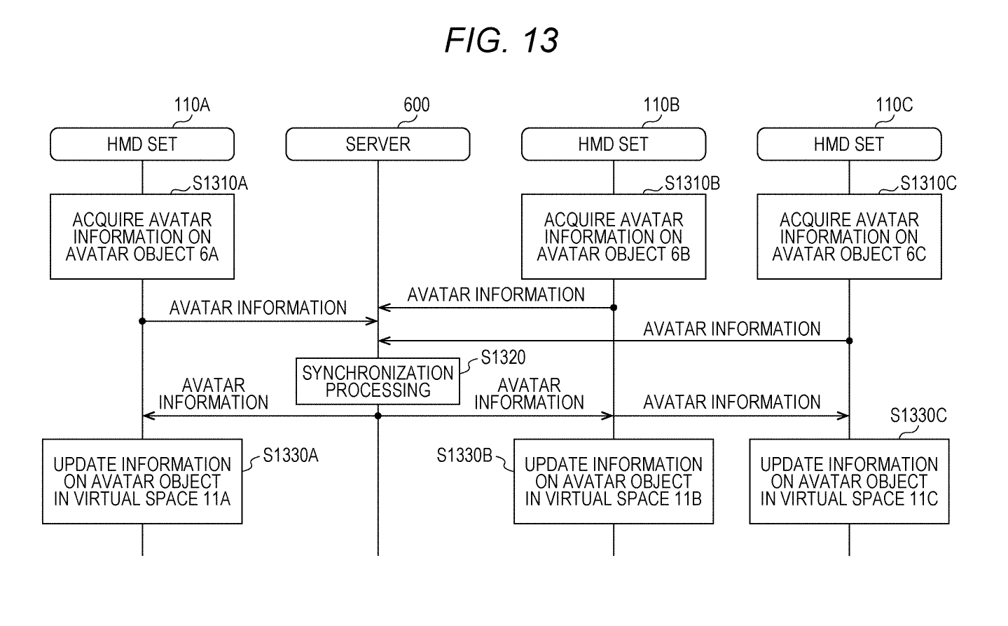

FIG. 13 is a flowchart of processing to be executed by the system 100 according to at least one embodiment of this disclosure. In FIG. 13, although the HMD set 110D is not included, the HMD set 110D operates in a similar manner as the HMD sets 110A, 110B, and 110C. Also in the following description, a reference numeral of each component related to the HMD set 110A, a reference numeral of each component related to the HMD set 110B, a reference numeral of each component related to the HMD set 110C, and a reference numeral of each component related to the HMD set 110D are appended by A, B, C, and D, respectively.

In Step S1310A, the processor 210A of the HMD set 110A acquires avatar information for determining a motion of the avatar object 6A in the virtual space 11A. This avatar information contains information on an avatar such as motion information, face tracking data, and sound data. The motion information contains, for example, information on a temporal change in position and inclination of the HMD 120A and information on a motion of the hand of the user 5A, which is detected by, for example, a motion sensor 420A. An example of the face tracking data is data identifying the position and size of each part of the face of the user 5A. Another example of the face tracking data is data representing motions of parts forming the face of the user 5A and line-of-sight data. An example of the sound data is data representing sounds of the user 5A acquired by the microphone 170A of the HMD 120A. In at least one embodiment, the avatar information contains information identifying the avatar object 6A or the user 5A associated with the avatar object 6A or information identifying the virtual space 11A accommodating the avatar object 6A. An example of the information identifying the avatar object 6A or the user 5A is a user ID. An example of the information identifying the virtual space 11A accommodating the avatar object 6A is a room ID. The processor 210A transmits the avatar information acquired as described above to the server 600 via the network 2.

In Step S1310B, the processor 210B of the HMD set 110B acquires avatar information for determining a motion of the avatar object 6B in the virtual space 11B, and transmits the avatar information to the server 600, similarly to the processing of Step S1310A. Similarly, in Step S1310C, the processor 210C of the HMD set 110C acquires avatar information for determining a motion of the avatar object 6C in the virtual space 11C, and transmits the avatar information to the server 600.

In Step S1320, the server 600 temporarily stores pieces of player information received from the HMD set 110A, the HMD set 110B, and the HMD set 110C, respectively. The server 600 integrates pieces of avatar information of all the users (in this example, users 5A to 5C) associated with the common virtual space 11 based on, for example, the user IDs and room IDs contained in respective pieces of avatar information. Then, the server 600 transmits the integrated pieces of avatar information to all the users associated with the virtual space 11 at a timing determined in advance. In this manner, synchronization processing is executed. Such synchronization processing enables the HMD set 110A, the HMD set 110B, and the HMD 120C to share mutual avatar information at substantially the same timing.

Next, the HMD sets 110A to 110C execute processing of Step S1330A to Step S1330C, respectively, based on the integrated pieces of avatar information transmitted from the server 600 to the HMD sets 110A to 110C. The processing of Step S1330A corresponds to the processing of Step S1180 of FIG. 11.

In Step S1330A, the processor 210A of the HMD set 110A updates information on the avatar object 6B and the avatar object 6C of the other users 5B and 5C in the virtual space 11A. Specifically, the processor 210A updates, for example, the position and direction of the avatar object 6B in the virtual space 11 based on motion information contained in the avatar information transmitted from the HMD set 110B. For example, the processor 210A updates the information (e.g., position and direction) on the avatar object 6B contained in the object information stored in the memory module 530. Similarly, the processor 210A updates the information (e.g., position and direction) on the avatar object 6C in the virtual space 11 based on motion information contained in the avatar information transmitted from the HMD set 110C.

In Step S1330B, similarly to the processing of Step S1330A, the processor 210B of the HMD set 110B updates information on the avatar object 6A and the avatar object 6C of the users 5A and 5C in the virtual space 11B. Similarly, in Step S1330C, the processor 210C of the HMD set 110C updates information on the avatar object 6A and the avatar object 6B of the users 5A and 5B in the virtual space 11C.

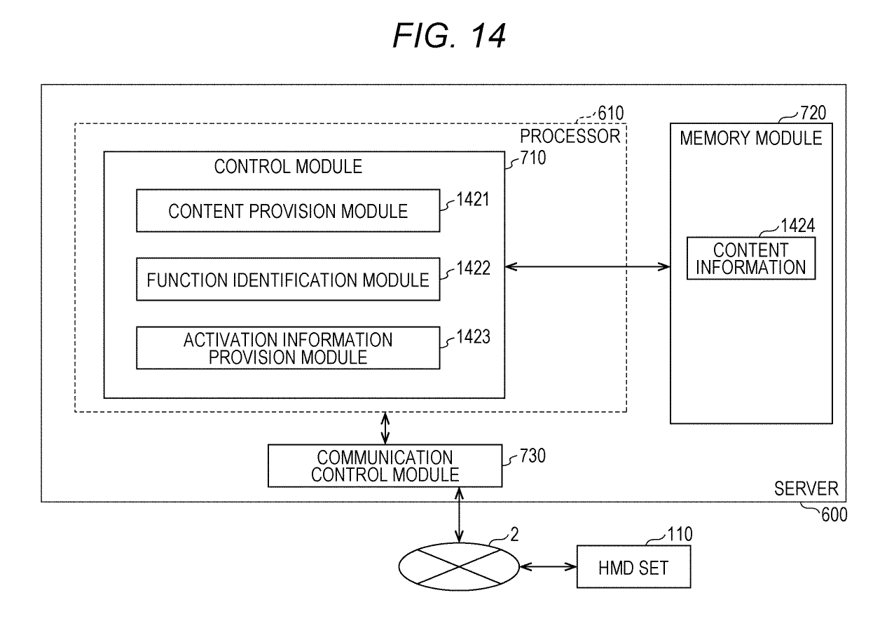

With reference to FIG. 14, a module configuration of the server 600 is described according to at least one embodiment. FIG. 14 is a block diagram of modules in the server 600 according to at least one embodiment of this disclosure.

In FIG. 14, the server 600 includes a control module 710, a memory module 720, and a communication control module 730. In at least one aspect, the control module 710 is implemented by the processor 610. In at least one aspect, a plurality of processors 610 may function as the control module 710. The memory module 720 is implemented by the memory 620 or the storage 630. The communication control module 730 is implemented by the communication interface 650.

The processing performed in the server 600 is implemented by hardware and software executed by the processor 610. In at least one embodiment, the software is stored in advance on a hard disk or other memory module 720. The data and programs stored in the memory module 720 are input by the administrator of the server 600.

In at least one aspect, the control module 710 may be implemented by combining the circuit elements for implementing each step of processing.

The communication control module 730 may communicate to/from the HMD sets 110 or other information communication devices via the network 2.

In FIG. 14, the control module 710 includes a content provision module 1421, a function identification module 1422, and an activation information provision module 1423.

The content provision module 1421 provides a piece of content specified by the computer 200, out of one or more pieces of content stored in content information 1424, to the computer 200.

The content is any content executable by the HMD sets 110 (the computer 200). In at least one aspect, the content is content executed by the HMD sets 110 to enable the user to experience virtual reality. Examples of this type of content include content that provides the user with the 360-degree virtual space 11 to enable the user to experience virtual reality. Examples of the content that provides the virtual space 11 include content in which objects appear in the 360-degree virtual space 11, and game content the user 5 plays in the 360-degree virtual space 11. The objects are virtual objects arranged in the virtual space 11, examples of which include the avatar objects and the operation object described above.

The content corresponds to one or more functions. Different types of content may correspond to different types and numbers of functions. Functions refer to such functions that can be executed, in synchronization with the content, by one or more peripheral devices that are available on the content executed on the HMD sets 110. Peripheral devices refer to peripheral devices of the computer 200 that are connected to the computer 200. Examples of the functions at least include a field-of-view position control function, a parallax function, an operation function, an olfactory function, and a tactile function.

The field-of-view position control function refers to a function for controlling the position of the field of view from the virtual camera 14 in the virtual space 11, depending on the position of the HMD 120. Examples of the peripheral devices for achieving the field-of-view position control function on the content include the HMD 120 and the HMD sensor 410 for achieving a position tracking function.

The parallax function refers to a function for causing the monitor 130 of the HMD 120 to display an image with parallax that represents the field of view from the virtual camera 14 in the virtual space 11 to allow the user to have a virtual experience in the virtual space 11. Examples of the peripheral devices for achieving the parallax function on the content include the HMD 120 having the monitor 130 capable of displaying parallax images.

The operation function refers to a function for moving an operation object in the virtual space 11 in synchronization with movement of any desired part of the body of the user. Examples of the operation function include a function for operating a virtual hand serving as an operation object arranged in the virtual space 11, based on movement of the user's hand carrying the controller 300. Examples of the peripheral device for achieving the operation function on the content include the controller 300.

The olfactory function refers to a function for generating a smell, virtually generated in the virtual space 11, also in the real space using an olfactory device (not illustrated), thereby enabling the user to perceive the smell generated in the virtual space 11. Examples of the peripheral device for achieving the olfactory function on the content include such an olfactory device (not illustrated) connectable with the computer 200.

The tactile function refers to a function for generating a tactile impression, virtually perceived by an avatar object or an operation object in the virtual space 11, also in the real space using a tactile device (not illustrated), thereby enabling the user to experience the tactile impression perceived by the avatar object or the operation object in the virtual space 11. Examples of the peripheral device for achieving the tactile function on the content include such a tactile device (not illustrated) connectable with the computer 200.

The function identification module 1422 identifies one or more functions that are achievable by one or more peripheral devices available on the content in synchronization with the content.

The activation information provision module 1423 provides the computer 200 with activation information that enables the computer 200 to activate a first function of the activation target on the content, out of one or more functions that are achievable on the content.

In at least one aspect, the memory module 720 stores the content information 1424. The content information 1424 stores content, function information, peripheral device information, and activation information.

On the content stored in the content information 1424, functions that are achievable in synchronization with peripheral devices are not necessarily activated. Simply acquiring content from the server 600 by the processor 210 of the computer 200 can therefore result in execution of content on which these functions fail to be on the computer 200. As described later, the processor 210 acquires content from the server 600, and then activates the function specified by user 5 as an activation target on the content, out of these functions. In this manner, the processor 210 may provide the user 5 with an opportunity for enjoying content in which any of the functions is achieved.

The function information refers to information indicating functions corresponding to a piece of content. The content information 1424 stores content and function information indicating functions corresponding to the content in association with each other. For example, when a certain piece of content corresponds to five different functions, the content information 1424 associates the content with five different pieces of function information indicating these functions.

The peripheral device information refers to information indicating a peripheral device corresponding to a function. The content information 1424 stores function information indicating a function and peripheral device information indicating a peripheral device corresponding to the function in association with each other. For example, in a case of the parallax function, the content information 1424 associates the function information indicating the parallax function with peripheral device information indicating the HMD 120, which is a peripheral device corresponding to the parallax function.

The activation information refers to information for activating a function on a piece of content. The content information 1424 stores function information indicating a function and activation information for activating the function in association with each other. For example, when the content corresponds to the parallax function, the content information 1424 further associates the function information indicating the parallax function with activation information for activating the parallax function. Examples of the activation information include an activation key for activating (releasing) a function not having been activated in the content. In other words, by using an activation key for the parallax function, the parallax function not having been activated in the content may be activated (released).

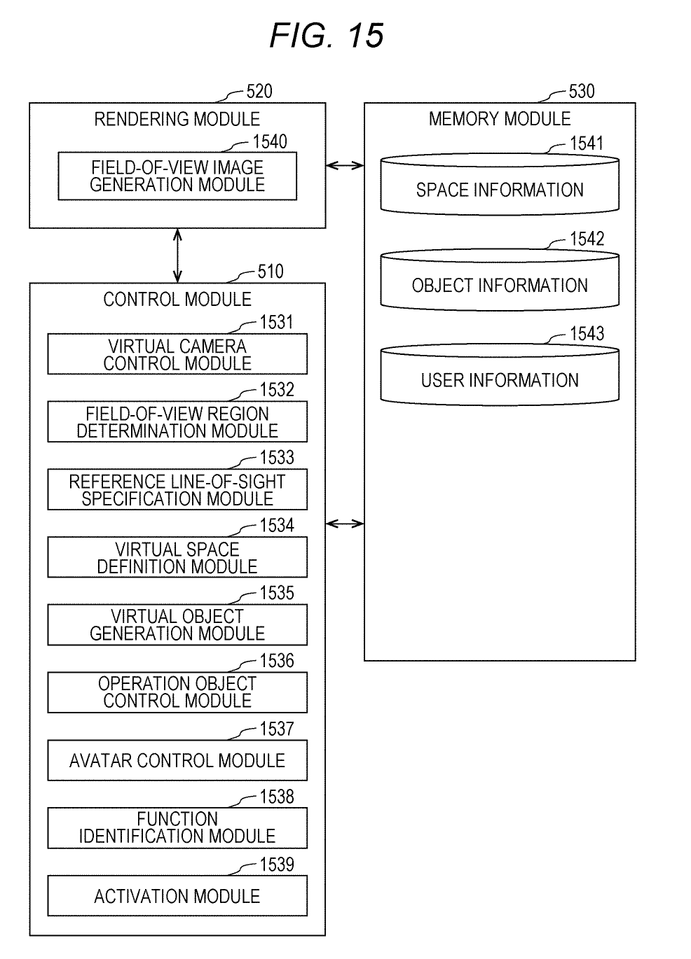

With reference to FIG. 15, a configuration of modules in the computer 200 is described according to at least one embodiment. FIG. 15 is a block diagram of a detailed configuration of modules in the computer 200 according to at least one embodiment of this disclosure.

As in FIG. 15, the control module 510 includes a function identification module 1538, an activation module 1539, a virtual camera control module 1531, a field-of-view region determination module 1532, a reference line-of-sight specification module 1533, a virtual space definition module 1534, a virtual object generation module 1535, an operation object control module 1536, and an avatar control module 1537. The rendering module 520 includes a field-of-view image generation module 1540. The memory module 530 stores space information 1541, object information 1542, and user information 1543.

The function identification module 1538 identifies one or more functions that are achievable by one or more peripheral apparatuses available on the content in synchronization with the content. The content is content executable on the computer 200.

The activation module 1539 activates a first function of the activation target on the content, out of one or more functions that are achievable on the content. The activation module 1539 acquires activation information for activating the first function from the server 600, and activates the first function on the content based on the activation information.

The virtual camera control module 1531 arranges the virtual camera 14 in the virtual space 11. The virtual camera control module 1531 controls the position at which the virtual camera 14 is arranged in the virtual space 11 and the direction (inclination) of the virtual camera 14. The virtual camera control module 1531 controls the position at which the virtual camera 14 is arranged in the virtual space 11, in accordance with the position of the HMD 120 when the field-of-view position control function is activated on the content. The field-of-view region determination module 1532 defines the field-of-view region 15 in accordance with the direction of the head of the user wearing the HMD 120 and the position at which the virtual camera 14 is arranged. The field-of-view image generation module 1540 generates the field-of-view region 17 to be displayed on the monitor 130 based on the determined field-of-view region 15. The field-of-view image generation module 1540 generates an image with parallax as the field-of-view region 17 and causes the monitor 130 to display the image when the parallax function is activated on the content.

The reference line-of-sight specification module 1533 specifies the line of sight of the user 5 based on the signal from the eye gaze sensor 140. The virtual space definition module 1534 generates virtual space data representing the virtual space 11, thereby defining the virtual space 11 in the HMD system 100. The virtual object generation module 1535 generates objects arranged in the virtual space 11. The objects may include, for example, forests, mountains, other landscapes, and animals to be arranged in accordance with the progression of the story of the game.

The operation object control module 1536 arranges, in the virtual space 11, an operation object for receiving an operation by the user in the virtual space 11. The user operates the operation object to, for example, operate an object arranged in the virtual space 11. In at least one aspect, the operation object may include, for example, a hand object corresponding to a hand of the user wearing the HMD 120. In at least one aspect, the operation object may correspond to a hand part of an avatar object to be described later.

The avatar control module 1537 generates data for arranging an avatar object of the user of another computer 200, which is connected via the network 2, in the virtual space 11. In at least one aspect, the avatar control module 1537 generates data for arranging an avatar object of the user 5 in the virtual space 11. In at least one aspect, the avatar control module 1537 generates an avatar object simulating the user 5 based on an image including the user 5. In at least one aspect, the avatar control module 1537 generates data for arranging an avatar object in the virtual space 11, which is selected by the user 5 from among a plurality of types of avatar objects (e.g., objects simulating animals or objects of deformed humans).

The avatar control module 1537 translates a motion of the HMD 120, which is detected by the HMD sensor 410, into an avatar object. For example, the avatar control module 1537 generates data for detecting inclination of the HMD 120 and arranging the avatar object in an inclined manner. In at least one aspect, the avatar control module 1537 translates a motion of the controller 300 into an avatar object. The avatar control module 1537 moves a virtual hand serving as an operation object arranged in the virtual space 11, based on movement of the user's hand carrying the controller 300, when the operation function is activated on the content. The operation object control module 1536 may perform this processing. The avatar control module 1537 generates a smell, virtually generated in the virtual space 11, also in the real space using an olfactory device (not illustrated), thereby enabling the user to perceive the smell generated in the virtual space 11, when the olfactory function is activated on the content. The avatar control module 1537 generates a tactile impression, virtually perceived by an avatar object or an operation object in the virtual space 11, also in the real space using a tactile device (not illustrated), thereby enabling the user to experience the tactile impression perceived by the avatar object or the operation object in the virtual space 11, when the tactile function is activated on the content.

The space information 1541 stores one or more templates defined in order to provide the virtual space 11.

The object information 1542 stores content to be played in the virtual space 11, objects used in the content, and information for arranging objects in the virtual space 11 (for example, position information). Examples of the content may include games and content representing landscapes similar to the ones in the real world.

The user information 1543 stores programs for causing the computer 200 to function as the control device of the HMD system 100 and application programs using various types of content stored in the object information 1542, for example.

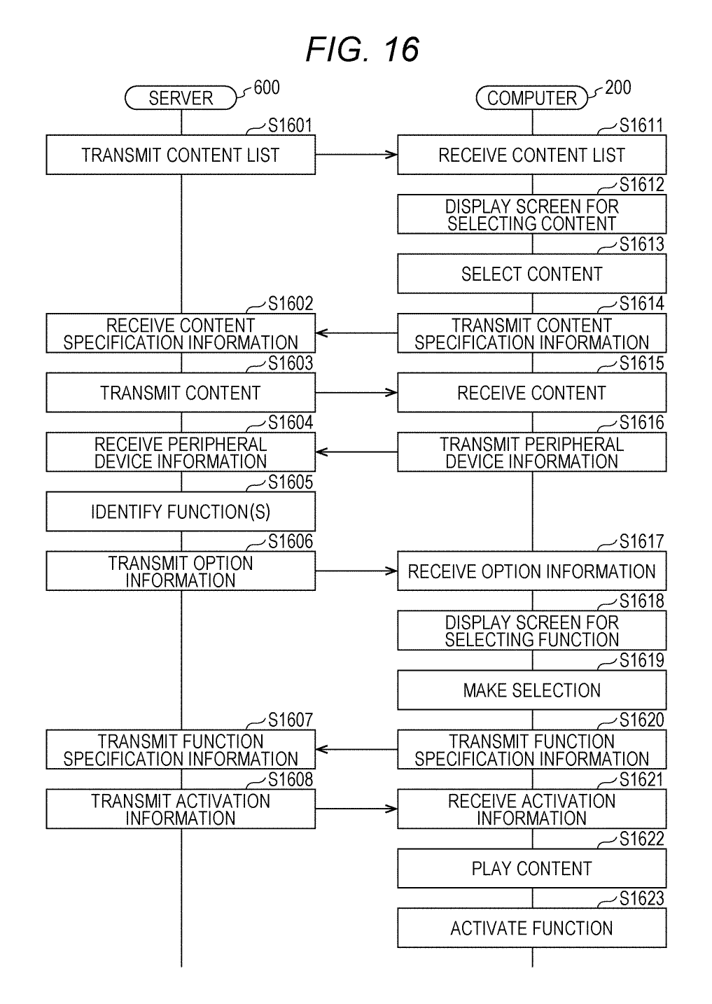

FIG. 16 is a flowchart of processing to be executed by the system including the HMD sets 110 and the server 600 according to at least one embodiment of this disclosure. Upon start of a series of processing illustrated in FIG. 16, the processor 610 of the server 600, functioning as the content provision module 1421, identifies one or more pieces of content executable by the HMD sets 110, out of a plurality of pieces of content stored in the content information 1424. The processor 610 generates a content list listing the identified one or more pieces of content. The content list includes, for example, the name, descriptive image, and descriptive text of each piece of content. In Step S1601, the processor 610 transmits the generated content list to the computer 200.

In Step S1611, the processor 210 of the computer 200 receives the content list transmitted from the server 600. In Step S1612, the processor 210, functioning as the rendering module 520, causes the monitor 130 to display a screen (not illustrated) content options for permitting a user to select a single piece of content out of one or more pieces of content, based on the received content list. This screen includes, for example, the names of pieces of content included in the content list as options. The user 5 may operate a keyboard, controller 300, a touch screen, or other operation apparatuses, thereby selecting an option corresponding to a single piece of content the user wants to execute on the HMD sets 110, from the content selection screen. In Step S1613, the processor 210 selects a single piece of content corresponding to the option selected by the user, based on an input made by the user 5.

The processor 210 generates content specification information (first information) specifying the selected content. In Step S1614, the processor 210 transmits the generated content specification information to the server 600. In Step S1602, the processor 610 of the server 600 receives the content specification information transmitted from the computer 200. The processor 610 acquires the content specified by the received content specification information from the content information 1424. In Step S1603, the processor 610 transmits the acquired content to the computer 200.

In Step S1615, the processor 210 receives the content transmitted from the server 600. The processor 210, functioning as the function identification module 1422, specifies one or more peripheral devices available on the received content, out of the peripheral devices provided to the HMD sets 110. For example, the processor 210 identifies the HMD 120, the HMD sensor 410, and the controller 300 as the one or more peripheral devices. The processor 210 generates peripheral device information indicating each of the identified peripheral devices. Specifically, the processor 210 generates peripheral device information, for each of the identified peripheral devices, indicating the HMD 120, peripheral device information indicating the HMD sensor 410, and peripheral device information indicating the controller 300. In Step S1616, the processor 210 transmits the pieces of generated peripheral device information to the server 600. For example, there are three pieces of generated peripheral device information when the HMD 120, the HMD sensor 410 and the controller are identified as peripheral devices.

In Step S1604, the processor 610 of the server 600 receives the pieces of peripheral device information transmitted from the computer 200. In Step S1605, the processor 610, functioning as the function identification module 1422, identifies one or more functions available on the content selected by the user 5, based on the three pieces of received peripheral device information. In this process, the processor 610 first identifies the content transmitted to the computer 200. The processor 610 then identifies, out of one or more pieces of function information associated with the identified content, one or more pieces of function information associated with the same peripheral device information as any piece of the received peripheral device information. The processor 610 identifies one or more functions indicated by the one or more pieces of identified function information as functions that are achievable on the content executed by the HMD sets 110. In this manner, the processor 610 identifies one or more functions that are achievable by the one or more peripheral devices provided to the HMD sets 110, out of the one or more functions that are achievable on the content.

In at least the example of FIG. 16, the processor 610 receives peripheral device information indicating the HMD 120, peripheral device information indicating the HMD sensor 410, and peripheral device information indicating the controller 300. In this manner, the processor 610 identifies the parallax function achieved by the HMD 120, the field-of-view position control function achieved by the HMD 120 and the HMD sensor 410, and the operation function achieved by the controller 300, as functions that are achievable on the content. In at least one embodiment, a smell provision function is achievable by the olfactory device is achievable on the content transmitted to the HMD sets 110. In this case, the content information 1424 stores content in which function information indicating the smell provision function and peripheral device information indicating the olfactory device are further associated with each other. Since the olfactory device is not connected to the computer 200 as a peripheral device, the processor 610 does not receive the peripheral device information indicating the olfactory device from the computer 200. The processor 610 therefore does not identify the smell provision function as a function that is achievable on the content executed by the computer 200. Similar considerations apply to the tactile device for which a detailed description is omitted for the sake of brevity.

The processor 610 acquires option information indicating one or more options separately corresponding to the one or more identified functions from the content information 1424. Specifically, the processor 210 acquires option information indicating an option corresponding to the parallax function, option information indicating an option corresponding to the field-of-view position control function, and option information indicating an option corresponding to the operation function. In Step S1606, the processor 610 transmits the pieces of acquired option information to the computer 200.

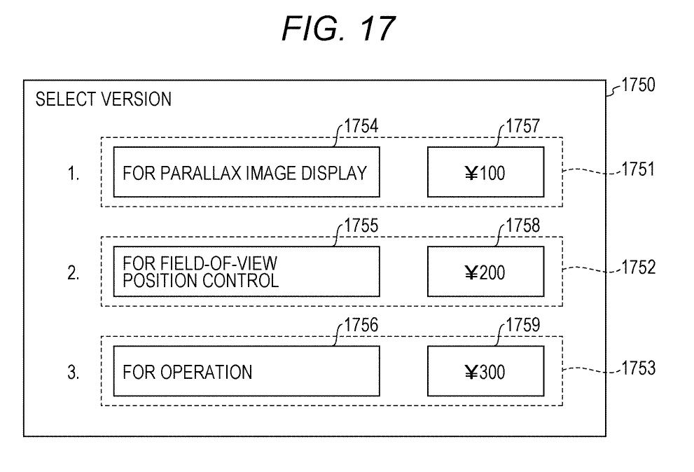

In Step S1617, the processor 210 receives the pieces of acquired option information transmitted from the server 600. In Step S1618, the processor 210 causes the display 430 to display a screen 1750 for enabling the user 5 to select a function to be activated, based on the pieces of received option information, as in FIG. 17.

FIG. 17 is a diagram of the screen 1750 for enabling the user 5 to select a function to be activated according to at least one embodiment of this disclosure. The screen 1750 is a screen for enabling the user 5 to select a function to be activated on the content. The screen 1750 in the FIG. 17 includes three different options 1751 to 1753 respectively corresponding to the three pieces of received option information. The option 1751 corresponds to the parallax function, the option 1752 corresponds to the field-of-view position control function, and the option 1753 corresponds to the operation function. The option 1751 includes a parallax function description 1754 and a condition 1757 for activating the parallax function. The option 1752 includes a field-of-view position control function description 1755 and a condition 1758 for activating the field-of-view position control function. The option 1753 includes an operation function description 1756 and a condition 1759 for activating the operation function.

The conditions 1757 to 1759 include the amount of money charged to the user 5 based on the corresponding functions. The condition 1757 includes the amount of money (100 yen) charged to the user 5, the condition 1758 includes the amount of money (200 yen) charged to the user 5, and the condition 1759 includes the amount of money (300 yen) charged to the user 5. In some embodiments, the amount may be free for any of the displayed options. For example, if activation of the parallax function corresponding to the condition 1757 is offered free of charge, the user 5 is further motivated to easily acquire and enjoy the content.

The user 5 may use a mouse, the controller 300, a touchscreen, a keyboard, or other operation apparatuses (not illustrated) included in the HMD sets 110, thereby selecting any option corresponding to a function to be activated out of the options 1751 to 1753. The user 5 selecting an option means the user 5 selecting the function corresponding to the option. In Step S1619, the processor 210 receives selection of any of the options made by the user 5. The processor 210 generates function specification information (second information) specifying the function corresponding to the selected option.

In Step S1620, the processor 210 transmits the generated function specification information to the server 600. In Step S1607, the processor 610 of the server 600 receives the function specification information transmitted from the computer 200.

The processor 610, functioning as the activation information provision module 1423, acquires activation information (third information) for activating the function selected by the user 5 on the content from the content information 1424, based on the received function specification information. Specifically, the processor 610 acquires activation information stored in the content information 1424 in association with the function information indicating the function specified by the received function specification information, from the content information 1424. In Step S1608, the processor 610 transmits the acquired activation information to the computer 200.

If the selected option includes the amount of money charged, the user 5 performs operation on the HMD sets 110 for paying the amount of money charged to a content service provider. The server 600 makes settlement of the amount of money charged included in the option selected by the user 5, based on the payment operation made by the user 5. Another server different from the server 600 may make settlement of the amount of money charged and notify the server 600 of a completion of the settlement. The processor 610 transmits activation information to the computer 200, after selection of a single option out of the three options 1751 to 1753 included in the screen 1750 and completion of the settlement of the amount of money charged included in the selected single option. In this manner, the processor 210 receives the activation information from the server 600, after selection of a single option out of the three options 1751 to 1753 included in the screen 1750 and completion of the settlement of the amount of money charged included in the selected single option. In at least one embodiment, if the user 5 fails to make settlement of the amount of money charged, then server 600 does not transmit the activation information.

In Step S1621, the processor 210 receives the activation information transmitted from the server 600. In Step S1622, the processor 210 plays the content downloaded from the server 600. In this process, the processor 210 performs a series of processing, as in FIG. 11, thereby defining the virtual space 11 and executing content in which virtual objects appear in the virtual space 11 on the computer 200, for example. The user 5 wearing the HMD 120 on his or her head may be thus immersed in the virtual space 11. In Step S1623, the processor 210 activates the selected function on the executed content, based on the received activation information.

When the option 1752 is selected, for example, the processor 210 activates the field-of-view position control function corresponding to the option 1752. In at least one aspect, a program module that achieves the field-of-view position control function achieved by the HMD sensor 410 in synchronization with the content is included in the content in advance. Furthermore, the content is configured such that execution of the program module that achieves the field-of-view position control function is not allowed before the field-of-view position control function is activated. In this case, activation information for activating the field-of-view position control function on the content is information for configuring the content to allow execution of the program module that achieves the field-of-view position control function. The processor 210 configures the content to allow execution of the program module that achieves the field-of-view position control function, based on the received activation information. Thus, the processor 210 executes the program module that achieves the field-of-view position control function, thereby activating the field-of-view position control function on the content.

In at least one aspect, the program module that achieves the field-of-view position control function is not included in the content in advance. In this case, activation information is a program module that achieves the field-of-view position control function in synchronization with the content. The processor 210 executes the received program module, thereby activating the field-of-view position control function on the content.

Although the example in FIG. 16 describes a case in which the processing for receiving the activation information is performed before the content is played, the processing for receiving the activation information may be performed after the content is played in at least one embodiment. In other words, the content may be played after Step S1615, followed by the processing in and after Step S1616. Although the example in FIG. 16 describes a case in which a function is activated while the content is being downloaded and played, the timing for activating the function is not limited to this, and may be at any timing from reception of the activation information to activation of the function after the content is downloaded in at least one embodiment.

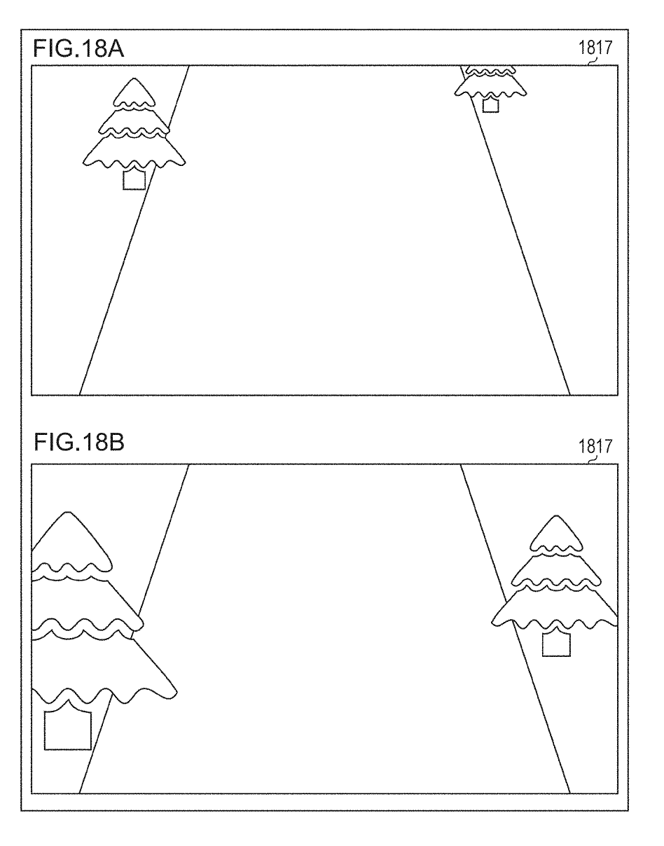

FIGS. 18A and 18B are diagrams of a field-of-view image 1817 according to at least one embodiment. When activating the field-of-view position control function corresponding to the option 1752 on the content, the processor 210 causes the monitor 130 to display the field-of-view image 1817 as in FIG. 18A. Since the field-of-view position control function is activated on the content, the user 5 may freely move in the virtual space 11. Specifically, the processor 210 moves the virtual camera 14 in the virtual space 11 in synchronization with the movement of the HMD 120 in the real space. As a result, the position of the field-of-view region 15 in the virtual space 11 is changed. The processor 210 generates the field-of-view image 1817 based on the changed field-of-view region 15, and causes the monitor 130 to display the image as in FIG. 18B. In the field-of-view image 1817 in FIG. 18B, the objects arranged in the virtual space 11 are displayed closer to the user 5 as the direction and distance of movement of the HMD 120 increase, than before the movement. The user 5 recognizes that, as a result of the movement of the user in the real space, the field-of-view image 1817 is switched from FIG. 18A to FIG. 18B and movement in a certain direction has been achieved in the virtual space 11.

In at least the example of FIGS. 18A and 18B, since the field-of-view position control function is activated on the content, the user 5 may freely move in the virtual space 11. This may allow the user 5 to enjoy the content corresponding to the virtual space 11 to a greater degree. At least one embodiment enables the user to experience the content with minimum functions. The user who becomes interested is allowed to add new functions through charging, which may increase opportunities for allowing the user to experience the content in greater depth. The field-of-view position control function uses, as described before, the HMD sensor 410 to track the position of the HMD 120. This may render the field-of-view position control function substantially unusable and no longer required in some cases because of environmental restrictions, such as small room space. Even under such circumstances, at least one embodiment enables the user to experience the content with limited functions. As long as the field-of-view position control function is activated, the user may be enabled to move to a specific location in the virtual space 11, to acquire a compensation, or to execute an additional scenario. This may motivate the user to activate the field-of-view position control function.

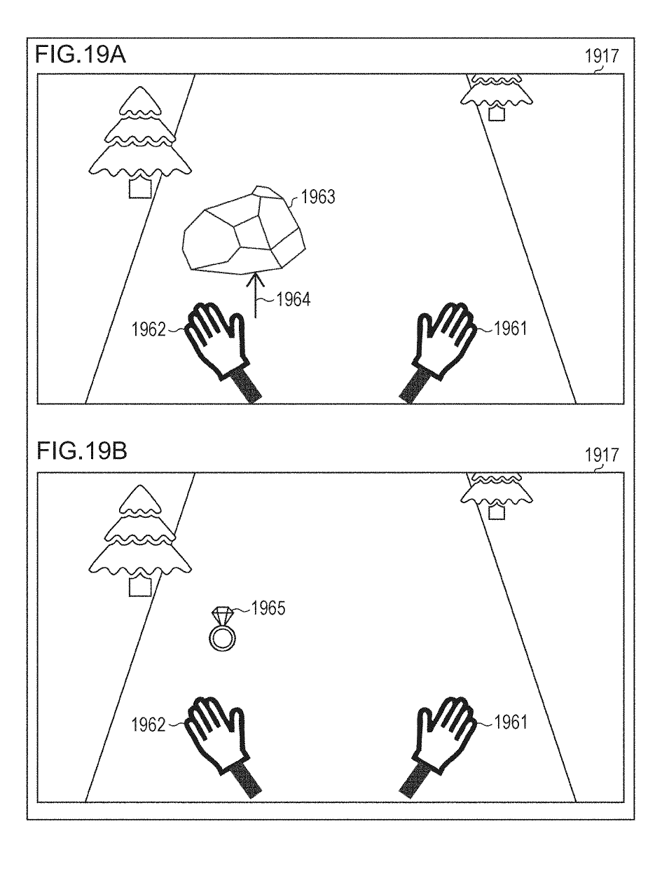

FIGS. 19A and 19B are diagrams of a field-of-view image 1917 according to at least one embodiment. When activating the operation function corresponding to the option 1753 on the content, the processor 210 causes the monitor 130 to display the field-of-view image 1917 as in FIG. 19A. In response to activation of the operation function on the content, the processor 210 generates a virtual right hand 1961 and a virtual left hand 1962 in the virtual space 11 to be operated, jointly or independently, using the controller 300. The processor 210 causes the monitor 130 to display a field-of-view image 1917 including the virtual right hand 1961, the virtual left hand 1962, and a rock object 1963.

The rock object 1963 is a type of virtual objects arranged in the virtual space 11. In the content being executed, the rock object 1963 is configured such that the user 5 will not be able to select the rock object without using the virtual right hand 1961 or the virtual left hand 1962.

In FIG. 19A, the operation function for operating the virtual right hand 1961 and the virtual left hand 1962 is activated on the content being executed. The user 5 operates the virtual left hand 1962, thereby moving the virtual left hand 1962 along a direction 1964 to bring the virtual left hand 1962 closer to the rock object 1963 in the virtual space 11 as in FIG. 19A. After the virtual left hand 1962 is brought sufficiently close to the rock object 1963, the user 5 further operates the virtual left hand 1962, thereby selecting (grasping) the rock object 1963 with the virtual left hand 1962.

If a first condition is satisfied as a result of the operation on the virtual left hand 1962, the processor 210 gives the user 5 a compensation. Examples of the first condition include selecting (grasping) the rock object 1963 with the virtual left hand 1962 or selecting and removing the rock object. Examples of the compensation include a rare item 1965. If the rock object 1963 is selected with the virtual left hand 1962, the processor 210 arranges the rare item 1965, in place of the rock object 1963, in the virtual space 11. The processor 210 further gives the user 5 the rare item 1965 thus arranged as a compensation, and updates the field-of-view image 1917 as in FIG. 19B. The field-of-view image 1917 in FIG. 19B includes the rare item 1965 given to the user 5.

In at least the example of FIGS. 19A and 19B, since the operation function is activated on the content corresponding to the virtual space 11, the user 5 may operate the virtual right hand 1961 and the virtual left hand 1962, thereby controlling objects arranged in the virtual space 11 in various aspects. This enables the user 5 to further enjoy the content corresponding to the virtual space 11.

The operation function executed on the content in at least the example of FIGS. 19A and 19B is an example of the control function for the virtual right hand 1961 and the virtual left hand 1962 by use of the controller 300. When the controller 300 has a vibration function or a tactile function, the content may support a feedback function that feeds back perception related to the virtual right hand 1961 and the virtual left hand 1962 by use of the controller 300 to the user 5. If the user 5 selects the feedback function to be activated, the processor 210 activates the feedback function on the content. With this configuration, the processor 210 may feed back perception related to the virtual right hand 1961 or the virtual left hand 1962 through vibrations of the controller 300 to the user 5 during execution of the content. This enables the user 5 to further enjoy the content corresponding to the virtual space 11.

If the first condition is satisfied based on operation on the virtual right hand 1961 or the virtual left hand 1962, the processor 210 may give the user 5 a right to advance to a bonus stage as a compensation. In at least one embodiment, a door object related to a bonus stage is arranged in the virtual space 11. In the content, this door object is configured such that the door object will not be open without using the virtual right hand 1961 or the virtual left hand 1962. If the user 5 opens the door object using the virtual left hand 1962, the processor 210 gives the user 5 a right to advance to a bonus stage that is located beyond the door object. Data for defining such a bonus stage is included in the content in advance as partial content. Alternatively, the processor 210 may newly download data for defining the bonus stage from the server 600.

The above-described activation scheme for functions on the content provides advantages to both the developers of the content and users 5 who enjoy the content. The developers of the content do not need to design different versions of content that support respective functions to suit particular needs of the users 5. In other words, the developers are able to design a single version of content that collectively supports one or more functions, in order to suit particular needs of the users 5 in a flexible manner. The cost related to the developers for designing the content may be thus lowered. While various types of HMD sets ranging from high-end to low-end have become widely used in recent years in particular, there is no need for designing different versions of content for respective content platforms or respective HMD sets. If saved data related to the content can be shared among different platforms of the content or among different HMD sets, the content executed with one platform or HMD set may be handed over to and executed with another platform or HMD set. This may encourage the user not only to experience the content by use of a low-end HMD set, but also to experience the content by use of a high-end HMD set. In other words, a user who has experienced the content with minimum functions by use of a low-end HMD set is encouraged to experience the content with a wider range of functions by use of a high-end HMD set.

The price of the content usually increases as the number of functions supported increases. In at least one embodiment, the user 5 enjoying the content may make a payment needed for activating some of the functions that suit his or her own needs, thereby separately activating the functions. This enables the user to purchase substantially less expensive content than in a case that requires purchase of more expensive content supporting some functions that do not suit the user's needs. For example, if the user owns no olfactory device, tactile device, or the like, the user does not benefit from an olfactory function or a tactile function. As another example, if the user suffers from rhinitis, the user is unlikely to benefit from an olfactory function. As yet another example, if the user is a child, the user will likely not benefit from a parallax function. At least one embodiment enables the users to experience the content with optimum functions in accordance with these particular preferences and situations of the users.

While some embodiments of the present disclosure have been described, the technical scope of the present disclosure is not construed in a limiting sense by the description of these embodiments. These embodiments are illustrative, and one of ordinary skill in the art would understand that various changes may be made in the embodiments without departing from the scope of the present invention set forth in the appended claims. The technical scope of the present invention should be defined based on the scope of the invention set forth in the appended claims and equivalents thereof.

Identification of one or more functions that are achievable on the content may be performed by the computer 200, instead of the server 600. In this case, the processor 610, as well as transmitting the specified content to the computer 200, transmits the entire function specification information and peripheral device information associated with the content in the content information 1424 to the computer 200. The processor 210 receives the transmitted content, function specification information, and peripheral device information. The processor 210 identifies one or more peripheral devices that are available on the received content, out of all the peripheral devices provided to the HMD sets 110. The processor 210 generates peripheral device information indicating each of the identified peripheral devices. The processor 210 identifies one or more pieces of function specification information associated with peripheral device information that is the same as any piece of the generated peripheral device information, out of the received entire function specification information. The processor 210 identifies one or more functions indicated by the one or more identified pieces of function information, as functions that are achievable by one or more peripheral devices connected to the computer 200, on the content executed by the computer 200.

The processor 210 may additionally activate a function that has not been activated on the content, after the content is executed. After the content is executed, the user 5 wears the HMD 120, and the processor 210 causes the monitor 130 to display the field-of-view image 17 in the virtual space 11. In this process, the processor 210 causes the monitor 130 to display the screen 1750 for enabling the user 5 to select a new function to be activated, after the content is executed. Specifically, the processor 210 causes the monitor 130 to display the field-of-view image 17 including the screen 1750. This enables the user 5 to activate a new function that is available on the content, while the user is immersed in the virtual space 11. In other words, the user 5 does not need to put off the HMD 120 from his or her head to view the display 430 in order to activate a new function on the content.

The processor 610 may also transmit option information corresponding to a function that is achievable by a peripheral device not connected to the computer 200 to the computer 200. In this case, the processor 210 causes the display 430 to display the screen 1750 including an option corresponding to the smell provision function, for example. The user 5 viewing this screen 1750 recognizes that the content supports the smell provision function, and expects to further enjoy the content through purchase of an olfactory device to be connected to the computer 200. The HMD system 100 may thus motivate the user 5 to purchase a new peripheral device not having been connected to the computer 200, such as the olfactory device.

[Notes]

Some aspects of embodiments of the present disclosure are summarized as follows.

(Item 1)

A system has been described. In at least one aspect of the present disclosure, instructions are executed in the computer 200 including the processor 210. The instructions cause the processor to perform: a step of transmitting first information for specifying content that is executable on the computer to the server 600 (S1614); a step of transmitting second information for specifying a first function to be activated, out of one or more functions that are achievable in association with the content by one or more peripheral devices that are available on the content, to a server; a step of receiving third information for activating the first function on the content from the server (S1621); and a step of activating the first function on the content based on the third information (S1623).

(Item 2)

In Item 1, the computer further includes a display (the display 430 or the monitor 130), the instructions further cause the processor to perform: a step of identifying one or more functions; a step of causing a display to display one or more options corresponding to the one or more respective functions; and a step of selecting one option corresponding to the first function, out of the one or more options, based on an input made by a user (S1619), and the second information is information for specifying the first function corresponding to the one selected option.

(Item 3)

In Item 2, each of the one or more options includes a description of the function corresponding to the option and a condition for activating the function corresponding to the option.

(Item 4)

The condition includes an amount of money charged to the user, and the step of receiving includes receiving the third information from the server after the one option is selected and the amount of money charged included in the one option is settled.

(Item 5)

In any of Item 1 to Item 4, the content is content in which a virtual object appears in a 360-degree virtual space, and the one or more functions are at least one of: a control function for the virtual object by use of the one or more peripheral devices, and a function of feeding back perception related to the virtual object by use of the one or more peripheral devices to the user.

(Item 6)

The first function is a function for operating the virtual object, and the program further causes the processor to perform a step of giving the user a compensation when a first condition is satisfied as a result of operation on the virtual object based on the first function.

(Item 7)

A system has been described. In at least one aspect of the present disclosure, instructions are executed in the server 600 including the processor 610. The instructions cause the processor to perform: a step of receiving first information for specifying content that is executable on user equipment (the computer 200) from the user equipment (S1602); a step of receiving second information for specifying a first function to be activated, out of one or more functions that are achievable in association with the content by one or more peripheral devices that are available on the content, from the user equipment (S1607); a step of acquiring third information for activating the first function on the content; and a step of transmitting the third information to the user equipment (S1608).

(Item 8)

In Item 7, the instructions further cause the processor to perform a step of identifying one or more functions (S1605) and a step of transmitting option information indicating one or more options corresponding to one or more respective functions to the user equipment (S1606).

(Item 9)

In Item 8, each of the one or more options includes a description of the function corresponding to the option and a condition for activating the function corresponding to the option.

(Item 10)

In Item 9, the condition includes an amount of money charged to the user, and the step of transmitting includes transmitting the third information to the user equipment after one option corresponding to the first function out of the one or more options is selected and the amount of money charged included in the one option is settled.

(Item 11)

In any of Item 7 to Item 10, the instructions further cause the processor to perform a step of transmitting content specified by the first information to the user equipment (S1601).

(Item 12)

An information processing apparatus has been described. In at least one aspect of the present disclosure, the information processing apparatus (the computer 200) includes a storage section (the storage 230) configured to store a program executed by the information processing apparatus; and a control section (the processor 210) configured to control operation of the information processing apparatus. The control section is configured to transmit first information for specifying content that is executable on the computer to the server; transmit second information for specifying a first function to be activated, out of one or more functions that are achievable in association with the content by one or more peripheral devices that are available on the content, to a server; receive third information for activating the first function on the content from the server; and activate the first function on the content based on the third information.

(Item 13)

A method for executing a program has been described. In at least one aspect of the present disclosure, the program is executed by the computer 200 including the processor 210. The program causes the processor to perform: a step of transmitting first information for specifying content that is executable on the computer to the server (S1614); a step of transmitting second information for specifying a first function to be activated, out of one or more functions that are achievable in association with the content by one or more peripheral devices that are available on the content, to a server (S1620); a step of receiving third information for activating the first function on the content from the server (S1621); and a step of activating the first function on the content based on the third information (S1623).

(Item 14)

An information processing apparatus has been described. In at least one aspect of the present disclosure, the information processing apparatus (the server 600) includes a storage section (the storage 630) configured to store a program executed by the information processing apparatus; and a control section (the processor 610) configured to control operation of the information processing apparatus. The control section is configured to receive first information for specifying content that is executable on user equipment (the computer 200) from the user equipment; receive second information for specifying a first function to be activated, out of one or more functions that are achievable in association with the content by one or more peripheral devices that are available on the content, from the user equipment; acquire third information for activating the first function on the content; and transmit the third information to the user equipment.

(Item 15)

A method for executing a program has been described. In at least one aspect of the present disclosure, the program is executed by the server 600 including the processor 610. The program causes the processor to perform: a step of receiving first information for specifying content that is executable on user equipment (the computer 200) from the user equipment (S1602); a step of receiving second information for specifying a first function to be activated, out of one or more functions that are achievable in association with the content by one or more peripheral devices that are available on the content, from the user equipment (S1607); a step of acquiring third information for activating the first function on the content; and a step of transmitting the third information to the user equipment (S1608).

In the at least one embodiment described above, the description is given by exemplifying the virtual space (VR space) in which the user is immersed using an HMD. However, a see-through HMD may be adopted as the HMD. In this case, the user may be provided with a virtual experience in an augmented reality (AR) space or a mixed reality (MR) space through output of a field-of-view image that is a combination of the real space visually recognized by the user via the see-through HMD and a part of an image forming the virtual space. In this case, action may be exerted on a target object in the virtual space based on motion of a hand of the user instead of the operation object. Specifically, the processor may identify coordinate information on the position of the hand of the user in the real space, and define the position of the target object in the virtual space in connection with the coordinate information in the real space. With this, the processor can grasp the positional relationship between the hand of the user in the real space and the target object in the virtual space, and execute processing corresponding to, for example, the above-mentioned collision control between the hand of the user and the target object. As a result, an action is exerted on the target object based on motion of the hand of the user.

What is claimed is:

1-9. (canceled)

10. A method comprising:
receiving content;
identifying a first peripheral device connected to a computer;
identifying a first function associated with the first peripheral device;
identifying a second peripheral device connected to the computer, wherein the second peripheral device is different from the first peripheral device;
identifying a second function associated with the second peripheral device, wherein the second function is different from the first function;
instructing a display to display a first option corresponding to the first function and a second option corresponding to the second function;
receiving an input from a user, wherein the input corresponds to selection of the first option or selection of the second option;
transmitting information based on the received input;
receiving instructions for activating the first function or the second function based on the transmitted information; and
activating the first function or the second function based on the received instructions.

11. The method according to claim 10, wherein transmitting the information comprises transmitting the information identifying the first peripheral device in response to the received input indicating selection of the first option,
wherein receiving the instructions comprises receiving the instructions indicating the first option, and
identifying the first function comprises identifying the first function based on the received instructions.

12. The method according to claim 10, wherein the received instructions include a description of the first function and a condition for activating the first function.

13. The method according to claim 12, wherein the condition comprises an amount of money charged to the user, for activating the first function.

14. The method according to claim 13, further comprising
charging the user the amount of money,
in response to the received input indicating selection of the first option.

15. The method according to claim 14, wherein receiving the instructions comprises receiving the instructions in response to payment of the amount of money.

16. The method according to claim 10, wherein
the content defines a 360-degree virtual space including a virtual object, and
the first function comprises at least one of a function for controlling the virtual object by use of the first peripheral device, or a function for providing a physical feedback for enabling the user to perceive operation related to the virtual object by use of the first peripheral device.

17. The method according to claim 16, wherein the first function comprises the function for controlling the virtual object, and the method further comprises
compensating the user in response to operation on the virtual object based on the first function.

18. The method according to claim 17, wherein
the virtual space includes an operation object configured to move in response to detection of movement of a body part of the user in a real space, and
the virtual object is operable in association with movement of the operation object.

19. The method according to claim 17, wherein the virtual object is omitted from the virtual space in response to failure to activate the first function.

20. The method according to claim 17, wherein the virtual object is arranged in the virtual space in response to activation of the first function.

21. The method according to claim 17, further comprising:
detecting control based on the first function executed on the virtual object;
controlling the virtual object based on the first function;
detecting control based on the second function executed on the virtual object; and
restricting control on the virtual object based on the second function.

22. A method comprising:
transmitting content to a computer;
receiving information based on the transmitted content, wherein the received information comprises:
first information related a first peripheral device connected to the computer;
second information related to a second peripheral device connected to the computer, wherein the second peripheral device is different from the first peripheral device;
transmitting options to the computer, wherein the options comprise:
a first option associated with a first function of the first peripheral device;
a second option associated with a second function of the second peripheral device, wherein the first function is different from the second function;
receiving a selection of the first option or the second option;
transmitting instructions for activating the first function or the second function based on the received selection, wherein the instructions are configured to activate the first function or the second function based on the received selection.

23. The method according to claim 22, wherein receiving the information comprises receiving the first information including information related to the first function, and receiving the second information including information related to the second function.

24. The method according to claim 22, further comprising:
identifying the first function based on the first information; and
identifying the second function based on the second information.

25. The method according to claim 22, wherein transmitting the options comprises transmitting a first fee associated with the first option and a second fee associated with the second option.

26. The method according to claim 25, wherein transmitting the instructions comprises transmitting the instructions in response to confirmation of payment of the first fee or the second fee.

27. The method according to claim 25, further comprising charging the user the first fee or the second fee in response to receiving the selection.

28. A system comprising:
a non-transitory computer readable medium configured to store instructions thereon; and
a processor connected to the non-transitory computer readable medium, wherein the processor is configured to execute the instructions for:
receiving content;
identifying a first peripheral device connected to the processor;
identifying a first function associated with the first peripheral device;
identifying a second peripheral device connected to the processor, wherein the second peripheral device is different from the first peripheral device;
identifying a second function associated with the second peripheral device, wherein the second function is different from the first function;
instructing a display to display a first option corresponding to the first function and a second option corresponding to the second function;
receiving an input from a user, wherein the input corresponds to selection of the first option or selection of the second option;
transmitting information based on the received input;
receiving instructions for activating the first function or the second function based on the transmitted information; and
activating the first function or the second function based on the received instructions.

29. The system of claim 28, further comprising a head-mounted display (HMD) connected to the processor, wherein the processor is configured to execute the instructions for instructing the HMD to display the first option and the second option.
